(19) United States
(12) Patent Application Publication
(10) Pub. No.: US 2026/0230002 A1
(43) Pub. Date: Aug. 6, 2026

(54) POWER CONVERTER

(71) Applicant: Panasonic Intellectual Property Management Co., Ltd., Osaka (JP)

(72) Inventors: Yutaka KAMON, Osaka (JP); Koji HIGASHIYAMA, Osaka (JP); Yasuhiro ARAI, Shiga (JP); Ryosuke MAEDA, Kyoto (JP)

(21) Appl. No.: 19/149,792

(22) PCT Filed: Jan. 26, 2024
(86) PCT No.: PCT/JP2024/002385

§ 371 Date: Jul. 21, 2025

(30) Foreign Application Priority Data
Feb. 2, 2023 (JP) 2023-014911

(51) Int. Cl. H02M 7/48; H02M 1/00; H02M 1/084; H02M 7/5387

(52) U.S. Cl. CPC H02M 7/4815; H02M 1/0009; H02M 1/084; H02M 7/53871

(57) ABSTRACT

A power converter includes a power converter circuit, a plurality of switches, a plurality of resonant capacitors, a resonant inductor, a regenerative capacitor, and a controller. The power converter circuit includes a plurality of first switching elements and a plurality of second switching elements. In the power converter, when determining that resonant currents passing respectively through two or more switches belonging to the plurality of switches be going to flow simultaneously through the resonant inductor, the controller performs shift control of shifting a high-level period of a control signal for at least one switch out of two or more switches to prevent the resonant currents passing respectively through the two or more switches from flowing simultaneously through the resonant inductor.

### DESCRIPTION

### Technical Field

The present disclosure generally relates to a power converter. More particularly, the present disclosure relates to a power converter having the ability to convert DC power into AC power.

### Background Art

Patent Literature 1 discloses a power converter for converting DC power into multiphase AC power.

The power converter of Patent Literature 1 includes a main switching means (power converter circuit), two capacitors, one coil (resonant inductor), a plurality of auxiliary switch elements, and a control means. The main switching means includes a plurality of main switching circuits provided for respective phases of the multiphase AC power. Each of the plurality of main switching circuits is implemented as a pair of main switch elements which are connected in series between both terminals of a DC power supply and uses, as the output node of its associated phase, the interconnection node of the pair of main switch elements. The two capacitors divide the voltage of the DC power supply. One end of the coil is connected to a voltage division node of the two capacitors. The plurality of auxiliary switch elements connect the other end of the coil and the output nodes of the respective phases. When determining that a plurality of phase currents be going to flow through the coil, the control means controls the plurality of auxiliary switch elements to make the amount of current flowing through at least one phase smaller than a preset amount.

### CITATION LIST

### Patent Literature

Patent Literature 1: JP 2010-233306 A

### SUMMARY OF INVENTION

In the power converter of Patent Literature 1, the control means controls, when determining that a plurality of phase currents be going to flow through the coil, the plurality of auxiliary switch elements to make the amount of current flowing through at least one phase smaller than the preset amount, and therefore, the control means does not make soft switching of a main switch corresponding to the at least one phase.

An object of the present disclosure is to provide a power converter having the ability to make soft switching with more reliability.

A power converter according to an aspect of the present disclosure includes a first DC terminal and a second DC terminal, a power converter circuit, a plurality of AC terminals, a plurality of switches, a plurality of resonant capacitors, a resonant inductor, a regenerative capacitor, and a controller. The power converter circuit includes a plurality of first switching elements and a plurality of second switching elements. In the power converter circuit, a plurality of switching circuits, in each of which one of the plurality of first switching elements and a corresponding one of the plurality of second switching elements are connected one to one in series, are connected to each other in parallel. In the power converter circuit, the plurality of first switching elements are connected to the first DC terminal, and the plurality of second switching elements are connected to the second DC terminal. The plurality of AC terminals are provided one to one for the plurality of switching circuits. Each of the plurality of AC terminals is connected to a connection node between the first switching element and the second switching element of a corresponding one of the plurality of switching circuits. The plurality of switches are provided one to one for the plurality of switching circuits. Each of the plurality of switches has a first end thereof connected to the connection node between the first switching element and the second switching element of a corresponding one of the plurality of switching circuits. The plurality of switches have their respective second ends connected in common to a common connection node. The plurality of resonant capacitors are provided one to one for the plurality of switches. Each of the plurality of resonant capacitors is connected between the first end of a corresponding one of the plurality of switches and the second DC terminal. The resonant inductor has a first end and a second end. In the resonant inductor, the first end of the resonant inductor is connected to the common connection node. The regenerative capacitor has a third end and a fourth end. In the regenerative capacitor, the third end is connected to either the first DC terminal or the second DC terminal. The controller applies a control signal, having a potential alternating between a high level and a low level, to each of the plurality of first switching elements, the plurality of second switching elements, and the plurality of switches. When determining that resonant currents passing respectively through two or more switches belonging to the plurality of switches be going to flow simultaneously through the resonant inductor, the controller performs shift control of shifting a high-level period of a control signal for at least one switch out of the two or more switches to prevent the resonant currents passing respectively through the two or more switches from flowing simultaneously through the resonant inductor.

A power converter according to the present disclosure achieves the advantage of enabling soft switching to be made with more reliability.

### BRIEF DESCRIPTION OF DRAWINGS

FIG. 1 is a circuit diagram of a system including a power converter according to a first embodiment;

FIG. 2 illustrates how the power converter operates in a situation where its controller has performed a basic operation when a load current>0 and its resonant capacitor is subjected to a charging operation;

FIG. 3 also illustrates how the power converter operates in the situation where its controller has performed the basic operation when the load current>0 and its resonant capacitor is subjected to the charging operation;

FIG. 4 shows how duties and load currents, respectively corresponding to three-phase voltage instructions in an AC load connected to a plurality of AC terminals of the power converter, change with time;

FIG. 5 shows a first current threshold value and a second current threshold value for use in the controller of the power converter;

FIG. 6 illustrates how the power converter operates in a situation where its controller has performed the basic operation when a load current>0 and its resonant capacitor is subjected to a discharging operation;

FIG. 7 illustrates how the power converter operates in a situation where its controller has performed the basic operation when the load current<0 and its resonant capacitor is subjected to the discharging operation;

FIG. 8 illustrates how the power converter operates in a situation where its controller has performed the basic operation when the load current<0 and its resonant capacitor is subjected to the charging operation;

FIG. 9 is a timing chart illustrating how its controller operates in the power converter;

FIG. 10 is a timing chart illustrating how its controller operates in the power converter;

FIG. 11 is a timing chart illustrating how its controller operates in the power converter;

FIG. 12 is a timing chart illustrating how its controller operates in a power converter according to a second embodiment;

FIG. 13 is a timing chart illustrating how its controller operates in the power converter;

FIG. 14 is a timing chart illustrating how its controller operates in the power converter;

FIG. 15 is a timing chart illustrating a situation where its controller has performed shift control in a power converter according to a third embodiment;

FIG. 16 is a timing chart illustrating a situation where its controller does not perform the shift control in the power converter;

FIG. 17 is a timing chart illustrating a situation where its controller has performed the shift control in the power converter;

FIG. 18 is a timing chart illustrating a situation where its controller does not perform the shift control in the power converter;

FIG. 19 is a timing chart illustrating a situation where its controller has performed shift control in a power converter according to a fourth embodiment;

FIG. 20 is a timing chart illustrating a situation where its controller has performed shift control in a power converter according to a fifth embodiment;

FIG. 21 is a timing chart illustrating a situation where its controller does not perform the shift control in the power converter;

FIG. 22 is a circuit diagram of a system including a power converter according to a sixth embodiment;

FIG. 23 is a circuit diagram of a system including a power converter according to a seventh embodiment;

FIG. 24 is a circuit diagram of a system including a power converter according to an eighth embodiment;

FIG. 25 is a circuit diagram of a system including a power converter according to a ninth embodiment;

FIG. 26 is a circuit diagram of a system including a power converter according to a tenth embodiment;

FIG. 27 is a circuit diagram of a system including a power converter according to an eleventh embodiment;

FIG. 28 is a circuit diagram of a system including a power converter according to a twelfth embodiment; and

FIG. 29 is a circuit diagram of a system including a power converter according to a thirteenth embodiment.

### DESCRIPTION OF EMBODIMENTS

### First Embodiment

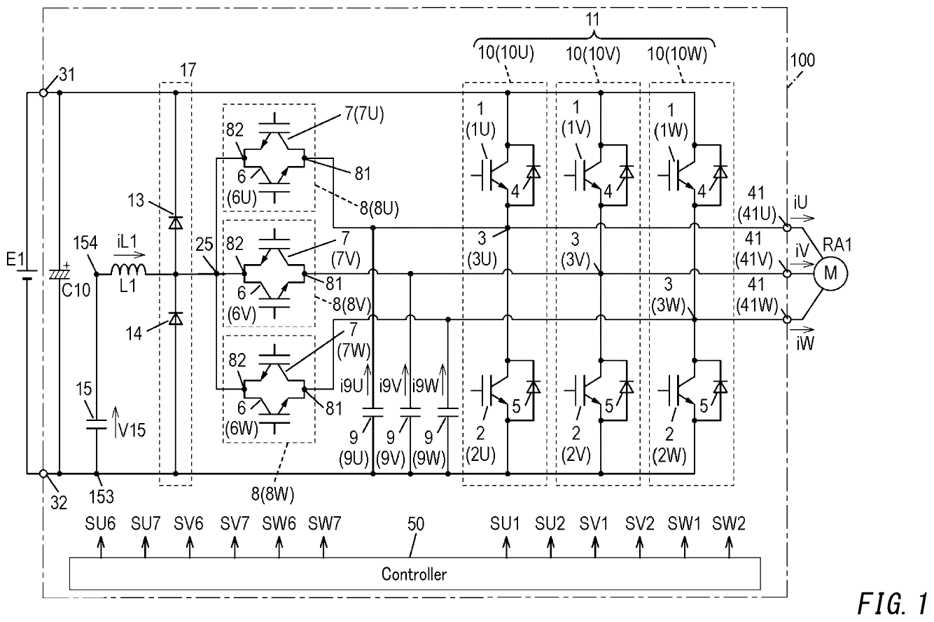

A power converter 100 according to a first embodiment will be described with reference to FIGS. 1-11.

### (1) Overall Configuration for Power Converter

The power converter 100 includes a first DC terminal 31 and a second DC terminal 32, and a plurality of (e.g., three) AC terminals 41 as shown in FIG. 1, for example. A DC power supply E1 is connected between the first DC terminal 31 and the second DC terminal 32. An AC load RA1 is connected to the plurality of AC terminals 41. The AC load RA1 may be, for example, a three-phase motor. The power converter 100 converts the DC output of the DC power supply E1 into AC power and outputs the AC power to the AC load RA1. The DC power supply E1 may include, for example, a solar cell or a fuel cell. The DC power supply E1 may include a DC-DC converter. In the power converter 100, if the plurality of AC terminals 41 are three AC terminals 41, then the AC power may be, for example, three-phase AC power having U-, V-, and W-phases.

The power converter 100 includes a power converter circuit 11, a plurality of (e.g., three) switches 8, a plurality of (e.g., three) resonant capacitors 9, a regenerative capacitor 15, a resonant inductor L1, and a controller 50. The power converter 100 further includes a protection circuit 17 and a capacitor C10. Each of the plurality of switches 8 may be, for example, a bidirectional switch.

The power converter circuit 11 includes a plurality of (e.g., three) first switching elements 1 and a plurality of (e.g., three) second switching elements 2. In the power converter circuit 11, a plurality of (e.g., three) switching circuits 10, in each of which one of the plurality of first switching elements 1 and a corresponding one of the plurality of second switching elements 2 are connected one to one in series, are connected in parallel. In the power converter circuit 11, the plurality of first switching elements 1 are connected to the first DC terminal 31 and the plurality of second switching elements 2 are connected to the second DC terminal 32. The plurality of AC terminals 41 are provided one to one for the plurality of switching circuits 10. Each of the plurality of AC terminals 41 is connected to a connection node 3 between the first switching element 1 and the second switching element 2 of a corresponding one of the plurality of switching circuits 10. The plurality of switches 8 are provided one to one for the plurality of switching circuits 10. Each of the plurality of switches 8 has a first end 81 thereof connected to the connection node 3 between the first switching element 1 and the second switching element 2 of a corresponding one of the plurality of switching circuits 10. The plurality of resonant capacitors 9 are provided one to one for the plurality of switches 8. Each of the plurality of resonant capacitors 9 is connected between the first end 81 of a corresponding one of the plurality of switches 8 and the second DC terminal 32. The resonant inductor L1 has a first end and a second end. The first end of the resonant inductor L1 is connected to a common connection node 25. The regenerative capacitor 15 has a third end 153 and a fourth end 154. In the regenerative capacitor 15, the third end 153 thereof is connected to the second DC terminal 32 and the fourth end 154 thereof is connected to the common connection node 25 via the resonant inductor L1. The controller 50 controls the plurality of first switching elements 1, the plurality of second switching elements 2, and the plurality of switches 8.

### (2) Details of Power Converter

In the following description, as for the plurality of switching circuits 10, the switching circuits 10 for the U-, V, and W-phases will be hereinafter referred to as a “switching circuit 10U,” a “switching circuit 10V,” and a “switching circuit 10W,” respectively, for the sake of convenience of description. Also, in the following description, the first switching element 1 and second switching element 2 of the switching circuit 10U will be hereinafter referred to as a “first switching element 1U” and a “second switching element 2U,” respectively. Likewise, in the following description, the first switching element 1 and second switching element 2 of the switching circuit 10V will be hereinafter referred to as a “first switching element 1V” and a “second switching element 2V,” respectively. Likewise, in the following description, the first switching element 1 and second switching element 2 of the switching circuit 10W will be hereinafter referred to as a “first switching element 1W” and a “second switching element 2W,” respectively. Furthermore, in the following description, the connection node 3 between the first switching element 1U and the second switching element 2U will be hereinafter referred to as a “connection node 3U,” the connection node 3 between the first switching element 1V and the second switching element 2V will be hereinafter referred to as a “connection node 3V,” and the connection node 3 between the first switching element 1W and the second switching element 2W will be hereinafter referred to as a “connection node 3W.” Furthermore, in the following description, the AC terminal 41 connected to the connection node 3U will be hereinafter referred to as an “AC terminal 41U,” the AC terminal 41 connected to the connection node 3V will be hereinafter referred to as an “AC terminal 41V,” and the AC terminal 41 connected to the connection node 3W will be hereinafter referred to as an “AC terminal 41W.” Furthermore, in the following description, the resonant capacitor 9 connected to the second switching element 2U in parallel will be hereinafter referred to as a “resonant capacitor 9U,” the resonant capacitor 9 connected to the second switching element 2V in parallel will be hereinafter referred to as a “resonant capacitor 9V,” and the resonant capacitor 9 connected to the second switching element 2W in parallel will be hereinafter referred to as a “resonant capacitor 9W.” Furthermore, in the following description, the switch 8 connected to the connection node 3U will be hereinafter referred to as a “switch 8U,” the switch 8 connected to the connection node 3V will be hereinafter referred to as a “switch 8V,” and the switch 8 connected to the connection node 3W will be hereinafter referred to as a “switch 8W.”

In the power converter 100, the higher-potential output terminal (positive electrode) of the DC power supply E1 is connected to the first DC terminal 31, and the lower-potential output terminal (negative electrode) of the DC power supply E1 is connected to the second DC terminal 32. Also, in the power converter 100, the U-, V, and W-phase terminals of the AC load RA1 are connected to the three AC terminals 41U, 41V, and 41W, respectively.

In the power converter circuit 11, each of the plurality of (e.g., three) first switching elements 1 and the plurality of (e.g., three) second switching elements 2 has a control terminal, a first main terminal, and a second main terminal. The respective control terminals of the plurality of first switching elements 1 and the plurality of second switching elements 2 are connected to the controller 50. In each of the plurality of switching circuits 10 of the power converter 100, the first main terminal of the first switching element 1 is connected to the first DC terminal 31, the second main terminal of the first switching element 1 is connected to the first main terminal of the second switching element 2, and the second main terminal of the second switching element 2 is connected to the second DC terminal 32. In each of the plurality of switching circuits 10, the first switching element 1 is a high-side switching element (P-side switching element) and the second switching element 2 is a low-side switching element (N-side switching element). Each of the plurality of first switching elements 1 and the plurality of second switching elements 2 may be, for example, an insulated gate bipolar transistor (IGBT). Thus, in each of the plurality of first switching elements 1 and the plurality of second switching elements 2, the control terminal, the first main terminal, and the second main terminal thereof are a gate terminal, a collector terminal, and an emitter terminal, respectively.

The power converter circuit 11 further includes a plurality of (e.g., three) first diodes 4 which are connected one to one to the plurality of (e.g., three) first switching elements 1 in antiparallel and a plurality of (e.g., three) second diodes 5 which are connected one to one to the plurality of (e.g., three) second switching elements 2 in antiparallel. In each of the plurality of first diodes 4, the anode of the first diode 4 is connected to the second main terminal (emitter terminal) of the first switching element 1 corresponding to the first diode 4, and the cathode of the first diode 4 is connected to the first main terminal (collector terminal) of the first switching element 1 corresponding to the first diode 4. In each of the plurality of second diodes 5, the anode of the second diode 5 is connected to the second main terminal (emitter terminal) of the second switching element 2 corresponding to the second diode 5, and the cathode of the second diode 5 is connected to the first main terminal (collector terminal) of the second switching element 2 corresponding to the second diode 5.

The U-phase terminal of the AC load RA1 may be connected, for example, to the connection node 3U between the first switching element 1U and the second switching element 2U via the AC terminal 41U. The V-phase of the AC load RA1 may be connected, for example, to the connection node 3V between the first switching element 1V and the second switching element 2V via the AC terminal 41V. The W-phase of the AC load RA1 may be connected, for example, to the connection node 3W between the first switching element 1W and the second switching element 2W via the AC terminal 41W.

The plurality of resonant capacitors 9 are provided one to one for the plurality of switches 8. Each of the plurality of resonant capacitors 9 is connected between the first end 81 of its corresponding switch 8 and the second DC terminal 32. The power converter 100 includes a plurality of resonant circuits. The plurality of resonant circuits includes a resonant circuit having the resonant capacitor 9U and the resonant inductor L1, a resonant circuit having the resonant capacitor 9V and the resonant inductor L1, and a resonant circuit having the resonant capacitor 9W and the resonant inductor L1. The plurality of resonant circuits shares the resonant inductor L1 in common.

Each of the plurality of switches 8 may include, for example, two IGBTs, namely, a first IGBT 6 and a second IGBT 7, which are connected together in antiparallel. In each of the plurality of switches 8, the collector terminal of the first IGBT 6 and the emitter terminal of the second IGBT 7 are connected to each other and the emitter terminal of the first IGBT 6 and the collector terminal of the second IGBT 7 are connected to each other. In each of the plurality of switches 8, the emitter terminal of the first IGBT 6 is connected to the connection node 3 of the switching circuit 10 corresponding to the switch 8 including the first IGBT 6. In each of the plurality of switches 8, the collector terminal of the second IGBT 7 is connected to the connection node 3 of the switching circuit 10 corresponding to the switch 8 including the second IGBT 7. The switch 8U is connected to the connection node 3U between the first switching element 1U and the second switching element 2U. The switch 8V is connected to the connection node 3V between the first switching element 1V and the second switching element 2V. The switch 8W is connected to the connection node 3W between the first switching element 1W and the second switching element 2W. In the following description, the first IGBT 6 and second IGBT 7 of the switch 8U will be hereinafter referred to as a “first IGBT 6U” and a “second IGBT 7U,” respectively, the first IGBT 6 and second IGBT 7 of the switch 8V will be hereinafter referred to as a “first IGBT 6V” and a “second IGBT 7V,” respectively, and the first IGBT 6 and second IGBT 7 of the switch 8W will be hereinafter referred to as a “first IGBT 6W” and a “second IGBT 7W,” respectively, for the sake of convenience of description.

The plurality of switches 8 are controlled by the controller 50. In other words, the first IGBT 6U, the second IGBT 7U, the first IGBT 6V, the second IGBT 7V, the first IGBT 6W, and the second IGBT 7W are controlled by the controller 50.

The resonant inductor L1 has a first end and a second end. In the resonant inductor L1, the first end of the resonant inductor L1 is connected to the common connection node 25 and the second end of the resonant inductor L1 is connected to the fourth end 154 of the regenerative capacitor 15.

The regenerative capacitor 15 is connected between the second end of the resonant inductor L1 and the second DC terminal 32. The regenerative capacitor 15 may be, for example, a film capacitor.

The protection circuit 17 includes a third diode 13 and a fourth diode 14. The third diode 13 is connected between the common connection node 25 and the first DC terminal 31. In the third diode 13, the anode of the third diode 13 is connected to the common connection node 25 and the cathode of the third diode 13 is connected to the first DC terminal 31. The fourth diode 14 is connected between the common connection node 25 and the second DC terminal 32. In the fourth diode 14, the anode of the fourth diode 14 is connected to the second DC terminal 32 and the cathode of the fourth diode 14 is connected to the common connection node 25. Thus, the fourth diode 14 is connected to the third diode 13 in series.

The capacitor C10 is connected between the first DC terminal 31 and the second DC terminal 32 and is connected to the power converter circuit 11 in parallel. The capacitor C10 may be, for example, an electrolytic capacitor.

The controller 50 controls the plurality of first switching elements 1, the plurality of second switching elements 2, and the plurality of switches 8. The agent that performs the functions of the controller 50 includes a computer system. The computer system includes a single or a plurality of computers. The computer system may include a processor and a memory as principal hardware components thereof. The computer system serves as the agent that performs the functions of the controller 50 according to the present disclosure by making the processor execute a program stored in the memory of the computer system. The program may be stored in advance in the memory of the computer system. Alternatively, the program may also be downloaded through a telecommunications line or be distributed after having been recorded in a non-transitory storage medium such as a memory card, an optical disc, or a hard disk drive (magnetic disk), any of which is readable for the computer system. The processor of the computer system may be made up of a single or a plurality of electronic circuits including a semiconductor integrated circuit (IC) or a large-scale integrated circuit (LSI). Those electronic circuits may be either integrated together on a single chip or distributed on multiple chips, whichever is appropriate. Those multiple chips may be aggregated together in a single device or distributed in multiple devices without limitation.

The controller 50 outputs control signals SU1, SV1, SW1 to control the ON/OFF states of the plurality of first switching elements 1U, 1V, 1W, respectively. Each of the control signals SU1, SV1, SW1 may be, for example, a pulse width modulation (PWM) signal having, for example, a potential level that alternates between a first potential level (hereinafter referred to as a “low level”) and a second potential level (hereinafter referred to as a “high level”) higher than the first potential level. The first switching elements 1U, 1V, 1W respectively turn ON when the control signals SU1, SV1, SW1 have high level and respectively turn OFF when the control signals SU1, SV1, SW1 have low level. In addition, the controller 50 also outputs control signals SU2, SV2, SW2 to control the ON/OFF states of the plurality of second switching elements 2U, 2V, 2W, respectively. Each of the control signals SU2, SV2, SW2 may be, for example, a PWM signal having, for example, a potential level that alternates between the first potential level (hereinafter referred to as a “low level”) and the second potential level (hereinafter referred to as a “high level”) higher than the first potential level. The second switching elements 2U, 2V, 2W respectively turn ON when the control signals SU2, SV2, SW2 have high level and respectively turn OFF when the control signals SU2, SV2, SW2 have low level.

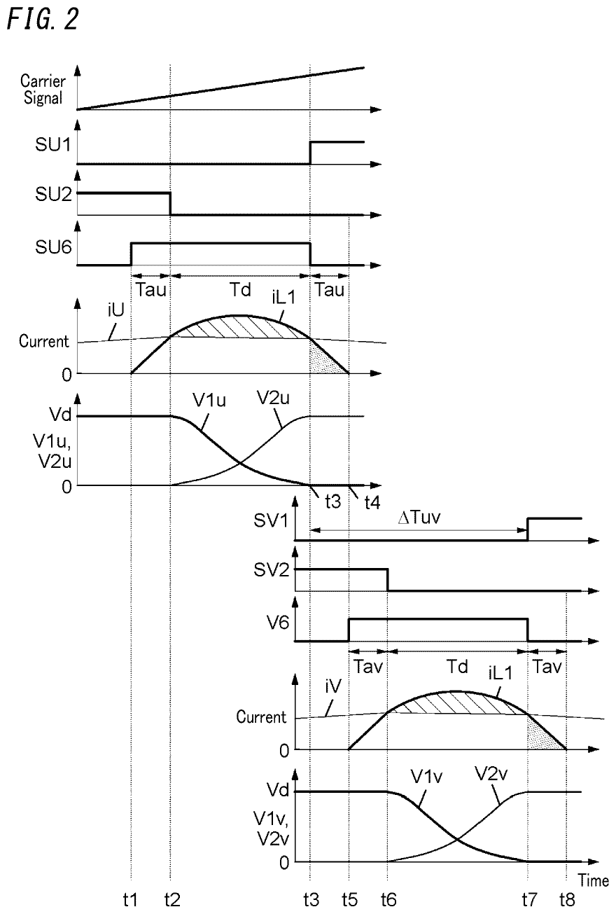

The controller 50 generates, using a carrier signal (refer to FIG. 2) having a saw-tooth waveform, the control signals SU1, SV1, SW1 for the plurality of first switching elements 1U, 1V, 1W, respectively, and the control signals SU2, SV2, SW2 for the plurality of second switching elements 2U, 2V, 2W, respectively. More specifically, the controller 50 generates, based on at least the carrier signal and a U-phase voltage instruction, the control signals SU1, SU2 to be applied to the first switching element 1U and the second switching element 2U, respectively. Also, the controller 50 generates, based on at least the carrier signal and a V-phase voltage instruction, the control signals SV1, SV2 to be applied to the first switching element 1V and the second switching element 2V, respectively. Furthermore, the controller 50 generates, based on at least the carrier signal and a W-phase voltage instruction, the control signals SW1, SW2 to be applied to the first switching element 1W and the second switching element 2W, respectively. The U-phase voltage instruction, the V-phase voltage instruction, and the W-phase voltage instruction may be, for example, sinusoidal wave signals, of which the phases are different from each other by 120 degrees and of which the amplitude (voltage instruction value) changes with time. Note that the waveform of the carrier signal does not have to be the saw-tooth waveform but may also be a triangular waveform or a mirror-reversed version of the saw-tooth waveform shown in FIG. 2. Also, the U-phase voltage instruction, the V-phase voltage instruction, and the W-phase voltage instruction each have one cycle of the same length. In addition, one cycle of the U-phase voltage instruction, the V-phase voltage instruction, and the W-phase voltage instruction is longer than one cycle of the carrier signal.

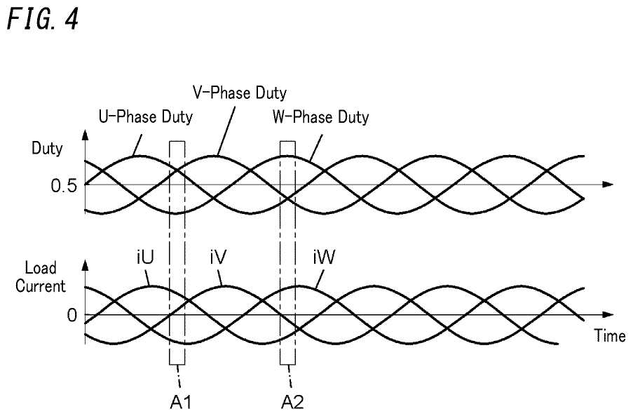

The duty of the control signals SU1, SU2 to be applied from the controller 50 to the first switching element 1U and the second switching element 2U, respectively, varies in accordance with the U-phase voltage instruction. In FIG. 4, the duty of the control signal SU1 is shown as a “U-phase duty.” The controller 50 (refer to FIG. 1) generates the control signal SU1 to be applied to the first switching element 1U by comparing the U-phase voltage instruction with the carrier signal. The controller 50 generates the control signal SU2 to be applied to the second switching element 2U by inverting the control signal SU1 to be applied to the first switching element 1U. In addition, to prevent the respective ON periods of the first switching element 1U and the second switching element 2U from overlapping with each other, the controller 50 sets a dead time period Td (refer to FIG. 2) between a high-level period of the control signal SU1 and a high-level period of the control signal SU2.

The duty of the control signals SV1, SV2 to be applied from the controller 50 to the first switching element 1V and the second switching element 2V, respectively, varies in accordance with the V-phase voltage instruction. In FIG. 2, the duty of the control signal SV1 is shown as a “V-phase duty.” The controller 50 (refer to FIG. 1) generates the control signal SV1 to be applied to the first switching element 1V by comparing the V-phase voltage instruction with the carrier signal. The controller 50 also generates the control signal SV2 to be applied to the second switching element 2V by inverting the control signal SV1 to be applied to the first switching element 1V. In addition, to prevent the respective ON periods of the first switching element 1V and the second switching element 2V from overlapping with each other, the controller 50 sets a dead time period Td (refer to FIG. 2) between a high-level period of the control signal SV1 and a high-level period of the control signal SV2.

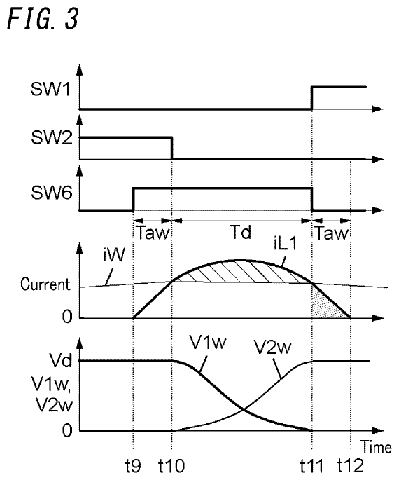

The duty of the control signals SW1, SW2 to be applied from the controller 50 to the first switching element 1W and the second switching element 2W, respectively, varies in accordance with the W-phase voltage instruction. In FIG. 4, the duty of the control signal SW1 is shown as a “W-phase duty.” The controller 50 (refer to FIG. 1) generates the control signal SW1 to be applied to the first switching element 1W by comparing the W-phase voltage instruction with the carrier signal. The controller 50 generates the control signal SW2 to be applied to the second switching element 2W by inverting the control signal SW1 to be applied to the first switching element 1W. In addition, to prevent the respective ON periods of the first switching element 1W and the second switching element 2W from overlapping with each other, the controller 50 sets a dead time period Td (refer to FIG. 3) between a high-level period of the control signal SW1 and a high-level period of the control signal SW2.

The U-phase voltage instruction, the V-phase voltage instruction, and the W-phase voltage instruction may be, for example, sinusoidal wave signals, of which the phases are different from each other by 120 degrees and of which the amplitude changes with time. Thus, the respective duties (i.e., U-, V-, and W-phase duties) of the control signals SU1, SV1, SW1 change in the form of sinusoidal waves, of which the phases are different from each other by 120 degrees, as shown in FIG. 4, for example. In the same way, the respective duties of the control signals SU2, SV2, SW2 also change in the form of sinusoidal waves, of which the phases are different from each other by 120 degrees.

The controller 50 generates the respective control signals SU1, SU2, SV1, SV2, SW1, SW2 based on the carrier signal, the respective voltage instructions, and information about the state of the AC load RA1. For example, if the AC load RA1 is a three-phase motor, the information about the state of the AC load RA1 may include, for example, detection values provided by a plurality of current sensors for respectively detecting output currents (hereinafter referred to as “load currents”) iU, iV, iW flowing respectively through the U-, V-, and W-phases of the AC load RA1.

The plurality of switches 8, the resonant inductor L1, the plurality of resonant capacitors 9, and the regenerative capacitor 15 are provided to make zero-voltage soft switching of the plurality of first switching elements 1 and the plurality of second switching elements 2.

In this power converter 100, the controller 50 controls not only the plurality of first switching elements 1 and the plurality of second switching elements 2 of the power converter circuit 11 but also the plurality of switches 8 as well.

The controller 50 generates control signals SU6, SU7, SV6, SV7, SW6, SW7 for controlling the respective ON/OFF states of the first IGBT 6U, the second IGBT 7U, the first IGBT 6V, the second IGBT 7V, the first IGBT 6W, and the second IGBT 7W, respectively, and outputs the control signals SU6, SU7, SV6, SV7, SW6, SW7 to the respective gate terminals of the first IGBT 6U, the second IGBT 7U, the first IGBT 6V, the second IGBT 7V, the first IGBT 6W, and the second IGBT 7W.

If the first IGBT 6U is ON and the second IGBT 7U is OFF, the switch 8U allows a charging current that flows through the regenerative capacitor 15, the resonant inductor L1, the switch 8U, and the resonant capacitor 9U in this order to pass therethrough. The charging current is a current for charging the resonant capacitor 9U with electricity. On the other hand, if the first IGBT 6U is OFF and the second IGBT 7U is ON, the switch 8U allows a discharging current that flows through the resonant capacitor 9U, the switch 8U, the resonant inductor L1, and the regenerative capacitor 15 in this order to pass therethrough. The discharging current is a current for discharging electricity from the resonant capacitor 9U.

If the first IGBT 6V is ON and the second IGBT 7V is OFF, the switch 8V allows a charging current that flows through the regenerative capacitor 15, the resonant inductor L1, the switch 8V, and the resonant capacitor 9V in this order to pass therethrough. The charging current is a current for charging the resonant capacitor 9V with electricity. On the other hand, if the first IGBT 6V is OFF and the second IGBT 7V is ON, the switch 8V allows a discharging current that flows through the resonant capacitor 9V, the switch 8V, the resonant inductor L1, and the regenerative capacitor 15 in this order to pass therethrough. The discharging current is a current for discharging electricity from the resonant capacitor 9V.

If the first IGBT 6W is ON and the second IGBT 7W is OFF, the switch 8W allows a charging current that flows through the regenerative capacitor 15, the resonant inductor L1, the switch 8W, and the resonant capacitor 9W in this order to pass therethrough. The charging current is a current for charging the resonant capacitor 9W with electricity. On the other hand, if the first IGBT 6W is OFF and the second IGBT 7W is ON, the switch 8W allows a discharging current that flows through the resonant capacitor 9W, the switch 8W, the resonant inductor L1, and the regenerative capacitor 15 in this order to pass therethrough. The discharging current is a current for discharging electricity from the resonant capacitor 9W.

### (3) Operation of Power Converter

In the following description, as for a current iL1 flowing through the resonant inductor L1, if the current flows in the direction indicated by the arrow shown in FIG. 1, then the polarity of the current iL1 is supposed to be positive. On the other hand, if the current iL1 flows in the direction opposite from the one indicated by the arrow shown in FIG. 1, then the polarity of the current iL1 is supposed to be negative. In addition, in the following description, as for each of the load currents iU, iV, iW respectively flowing through the U-, V-, and W-phases of the AC load RA1, if the load current iU, iV, iW flows in the direction indicated by a corresponding one of the arrows shown in FIG. 1, then the polarity of the load current iU, iV, iW is supposed to be positive. On the other hand, if the load current iU, iV, iW flows in the opposite direction from the one indicated by the arrow shown in FIG. 1, then the polarity of the load current iU, iV, iW is supposed to be negative. Furthermore, as for each of currents i9U, i9V, i9W flowing through the resonant capacitors 9U, 9V, 9W, respectively, if the current i9U, i9V, i9W flows in the direction indicated by a corresponding one of the arrows shown in FIG. 1, then the polarity of the current i9U, i9V, i9W is supposed to be positive. On the other hand, if the current i9U, i9V, i9W flows in the direction opposite from the one indicated by the arrow shown in FIG. 1, then the polarity of the current i9U, i9V, i9W is supposed to be negative. Thus, in the case of the discharging operation of discharging electricity from the resonant capacitor 9U, 9V, 9W, the polarity of the current i9U, i9V, i9W is positive. On the other hand, in the case of the charging operation of charging the resonant capacitor 9U, 9V, 9W with electricity, the polarity of the current i9U, i9V, i9W is negative.

In this power converter 100, the first IGBT 6U of the switch 8U may turn OFF in a state where the first IGBT 6U of the switch 8U is ON and a positive current iL1 is flowing through the resonant inductor L1, for example. In that case, the current iL1 flowing through the resonant inductor L1 is regenerated to the power converter circuit 11 via the third diode 13 until the current iL1 goes zero due to the consumption of energy of the resonant inductor L1. Also, in this power converter 100, the second IGBT 7U of the switch 8U may turn OFF in a state where the second IGBT 7U of the switch 8U is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

Furthermore, in this power converter 100, the first IGBT 6V of the switch 8V may turn OFF in a state where the first IGBT 6V of the switch 8V is ON and a positive current iL1 is flowing through the resonant inductor L1, for example. In that case, the current iL1 flowing through the resonant inductor L1 is regenerated to the power converter circuit 11 via the third diode 13 until the current iL1 goes zero due to the consumption of energy of the resonant inductor L1. Furthermore, in this power converter 100, the second IGBT 7V of the switch 8V may turn OFF in a state where the second IGBT 7V of the switch 8V is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

Furthermore, in this power converter 100, the first IGBT 6W of the switch 8W may turn OFF in a state where the first IGBT 6W of the switch 8W is ON and a positive current iL1 is flowing through the resonant inductor L1, for example. In that case, the current iL1 flowing through the resonant inductor L1 is regenerated to the power converter circuit 11 via the third diode 13 until the current iL1 goes zero due to the consumption of energy of the resonant inductor L1. Furthermore, in this power converter 100, the second IGBT 7W of the switch 8W may turn OFF in a state where the second IGBT 7W of the switch 8W is ON and a negative current iL1 is flowing through the resonant inductor L1, for example. In that case, the current iL1 flows through the resonant inductor L1 along the path passing through the fourth diode 14, the resonant inductor L1, and the regenerative capacitor 15 in this order until the current iL1 goes zero due to the consumption of energy of the resonant inductor L1.

The controller 50 sets, with respect to each of the plurality of switching circuits 10, a dead time period Td between a high-level period of the control signal SU1, SV1, SW1 for the first switching element 1U, 1V, 1W and a high-level period of the control signal SU2, SV2, SW2 for the second switching element 2U, 2V, 2W.

Next, a basic operation of zero-voltage soft switching to be performed on each of the plurality of first switching elements 1 and the plurality of second switching elements 2 will be described with reference to FIGS. 1-8. As used herein, the “basic operation” refers to an operation to be performed when a resonant current, passing through each of two or more switches 8 belonging to the plurality of switches 8, does not flow simultaneously through the resonant inductor L1. It will be described, after the basic operation has been described, how this power converter 100 operates when the controller 50 determines that the resonant currents passing through the two or more switches 8 belonging to the plurality of switches 8 be going to flow simultaneously.

### (3.1) Basic Operation

When the zero-voltage soft switching is performed on the first switching element 1, the voltage across the first switching element 1 needs to be reduced to zero just before the first switching element 1 as the target of zero-voltage soft switching turns ON. When the zero-voltage soft switching is performed on the second switching element 2, the voltage across the second switching element 2 needs to be reduced to zero just before the second switching element 2 as the target of zero-voltage soft switching turns ON. In the following description, the switching element (which is either the first switching element 1 or the second switching element 2) as the target of the zero-voltage soft switching will be hereinafter referred to as a “target switching element.”

The basic operation of the controller 50 changes according to the polarity (i.e., either positive or negative) of a load current flowing through the AC terminal 41 connected to the target switching element and depending on whether the resonant capacitor 9 connected to the target switching element in series or in parallel is performing the charging operation or the discharging operation. The load current has positive polarity when flowing from the AC terminal 41 toward the AC load RA1 and has negative polarity when flowing from the AC load RA1 toward the AC terminal 41. While the resonant capacitor 9 is performing the charging operation, the voltage across the resonant capacitor 9 increases. On the other hand, while the resonant capacitor 9 is performing the discharging operation, the voltage across the resonant capacitor 9 decreases. The voltage across each of the plurality of second switching elements 2 is the same as the voltage across the resonant capacitor 9 connected to the second switching element 2 in parallel.

### (3.1.1) Operation of Soft-Switching First Switching Element When Load Current>0

If the target of the soft switching is a first switching element 1 (hereinafter referred to as a “target first switching element 1”) and the polarity of the load current flowing through the AC terminal 41 connected to the target first switching element 1 is positive, then the controller 50 turns ON the first IGBT 6 corresponding to the target first switching element 1. In this manner, the controller 50 causes the resonant inductor L1 and resonant capacitor 9 connected to the target first switching element 1 to produce resonance, thereby charging the resonant capacitor 9 with electric charges supplied from the regenerative capacitor 15 and reducing the voltage across the target first switching element 1 to zero. This allows the power converter 100 to make zero-voltage soft switching of the target first switching element 1.

The control signals SU1, SU2 to be respectively applied from the controller 50 to the first switching element 1U and the second switching element 2U of the switching circuit 10U in a situation where the target first switching element is the first switching element 1U of the switching circuit 10U are shown in FIG. 2. In addition, the control signal SU6 to be applied from the controller 50 to the first IGBT 6U of the switch 8U, the load current iU flowing through the U-phase of the AC load RA1, the current iL1 flowing through the resonant inductor L1, the voltage V1u across the first switching element 1U, and the voltage V2u across the second switching element 2U are also shown in FIG. 2. Furthermore, the control signals SV1, SV2 to be respectively applied from the controller 50 to the first switching element 1V and the second switching element 2V of the switching circuit 10V in a situation where the target first switching element is the first switching element 1V of the switching circuit 10V are also shown in FIG. 2. In addition, the control signal SV6 to be applied from the controller 50 to the first IGBT 6V of the switch 8V, the load current iV flowing through the V-phase of the AC load RA1, the current iL1 flowing through the resonant inductor L1, the voltage V1v across the first switching element 1V, and the voltage V2v across the second switching element 2V are also shown in FIG. 2.

Furthermore, the dead time period Td that the controller 50 sets to prevent the first switching element 1 and the second switching element 2 of the same phase from turning ON simultaneously is also shown in FIG. 2. Besides, an additional time Tau set by the controller 50 with respect to the control signal SU6 for the first IGBT 6U of the switch 8U and an additional time Tav set by the controller 50 with respect to the control signal SV6 for the first IGBT 6V of the switch 8V are also shown in FIG. 2. The additional time Tau and the additional time Tav will be described later.

The control signals SW1, SW2 to be respectively applied from the controller 50 to the first switching element 1W and the second switching element 2W of the switching circuit 10W in a situation where the target first switching element is the first switching element 1W of the switching circuit 10W are shown in FIG. 3. In addition, the control signal SW6 to be applied from the controller 50 to the first IGBT 6W of the switch 8W and the load current iW flowing through the W-phase of the AC load RA1 are also shown in FIG. 3. The current iL1 flowing through the resonant inductor L1 is also shown in FIG. 3. The voltage V1w across the first switching element 1W and the voltage V2w across the second switching element 2 are also shown in FIG. 3. In FIG. 3, the voltage value of the DC power supply E1 is designated by Vd.

Furthermore, the dead time period Td that the controller 50 sets to prevent the first switching element 1W and the second switching element 2W from turning ON simultaneously is also shown in FIG. 3. Besides, an additional time Taw set by the controller 50 with respect to the control signal SW6 for the first IGBT 6W of the switch 8W is also shown in FIG. 3. The additional time Taw will be described later.

The additional time Tau is an amount of time that the controller 50 provides to make the high-level period of the control signal SU6 longer than the dead time period Td by setting the beginning time t1 of the high-level period of the control signal SU6 at a point in time earlier than the beginning time t2 of the dead time period Td as shown in FIG. 2. The length of the additional time Tau is determined by the value of the load current iU. To start producing the LC resonance from the beginning time t2 of the dead time period Td, it is preferable that the value of the current iL1 agree with the value of the load current iU at the beginning time t2 of the dead time period Td. This is because as long as iL1<iU is satisfied, all of the current iL1 flows through the AC load RA1, and therefore, the resonant capacitor 9U cannot be charged. The end time of the high-level period of the control signal SU6 may be simultaneous with, or later than, the end time t3 of the dead time period Td. In the example shown in FIG. 2, the end time of the high-level period of the control signal SU6 is set to be simultaneous with the end time t3 of the dead time period Td. The controller 50 sets the high-level period of the control signal SU6 at Tau+Td. In the switching circuit 10U, the voltage V2u across the second switching element 2U becomes Vd at the end time t3 of the dead time period Td, and the voltage V1u across the first switching element 1U goes zero at the end time t3 of the dead time period Td. In the example shown in FIG. 2, the current iL1 starts flowing through the resonant inductor L1 at the beginning time tl of the high-level period of the control signal SU6 and goes zero at a time t4 when the additional time Tau has passed since the end time t3 of the dead time period Td. As for the current iL1, the current iL1 satisfies iL1≥iU from the beginning time t2 of the dead time period Td, and therefore, the current iL1 in the hatched part of the current waveform shown as the fifth waveform from the top of FIG. 2 flows into the resonant capacitor 9U to produce LC resonance. From the end time t3 of the dead time period Td and on, the current iL1 will be regenerated to the power converter circuit 11 via the third diode 13 directly connected to the resonant inductor L1.

To start producing the LC resonance at the beginning time t2 of the dead time period Td and end a resonant half cycle at the end time of the dead time period Td as described above, the controller 50 determines the additional time Tau based on the load current iU such that iL1=iU is satisfied at the beginning time t2 of the dead time period Td. More specifically, using either the detection result of the load current iU by a current sensor or a signal processing value thereof, or an estimated value of the load current iU, the inductance L of the resonant inductor L1 that has been stored in advance, and the detection result of the potential V15 at the regenerative capacitor 15, for example, the controller 50 determines the additional time Tau by the equation: Tau=iU×(L/V15). In this case, as the detection result of the load current iU or the signal processing value thereof, either a detection value at a carrier cycle at which the additional time Tau is added or a detection value at a timing closest to the carrier cycle may be used. Also, in this case, as the estimated value of the load current iU, a value of the load current iU estimated at the carrier cycle at which the additional time Tau is added may be used, for example. The resonant half cycle in the case of the basic operation is one half of a resonant cycle, which is the reciprocal of the resonant frequency of a resonant circuit including the resonant inductor L1 and one resonant capacitor 9. Thus, if the inductance of the resonant inductor L1 is L and the capacitance of the resonant capacitor 9 is C, then the resonant half cycle is π×(L·C)^{1/2}. The controller 50 sets the resonant half cycle in the case of the basic operation to make the resonant half cycle as long as the length of the dead time period Td, for example.

The additional time Tav is an amount of time that the controller 50 provides to make the high-level period of the control signal SV6 longer than the dead time period Td by setting the beginning time t5 of the high-level period of the control signal SV6 at a point in time earlier than the beginning time t6 of the dead time period Td as shown in FIG. 2. The length of the additional time Tav is determined by the value of the load current iV. To start producing LC resonance from the beginning time t6 of the dead time period Td, it is preferable that the value of the current iL1 agree with the value of the load current iV at the beginning time t6 of the dead time period Td. This is because as long as iL1<iV is satisfied, all of the current iL1 flows through the AC load RA1, and therefore, the resonant capacitor 9V cannot be charged. The end time of the high-level period of the control signal SV6 may be simultaneous with, or later than, the end time t7 of the dead time period Td. In the example shown in FIG. 2, the end time of the high-level period of the control signal SV6 is set to be simultaneous with the end time t7 of the dead time period Td. The controller 50 sets the high-level period of the control signal SV6 at Tav+Td. The voltage V1V across the first switching element 1V goes zero at the end time t7 of the dead time period Td. In the example shown in FIG. 2, the current iL1 starts flowing through the resonant inductor L1 at the beginning time t5 of the high-level period of the control signal SV6 and goes zero at a time t8 when the additional time Tav has passed since the end time t7 of the dead time period Td. As for the current iL1, the current iL1 satisfies iL1>iV from the beginning time t6 of the dead time period Td and on, and therefore, the current iL1 in the hatched part of the current waveform shown as the tenth waveform from the top of FIG. 2 flows into the resonant capacitor 9V to produce the LC resonance. From the end time t7 of the dead time period Td and on, the current iL1 will be regenerated to the power converter circuit 11 via the third diode 13 directly connected to the resonant inductor L1.

To start producing the LC resonance at the beginning time t6 of the dead time period Td as described above, the controller 50 determines the additional time Tav based on the load current iV such that iL1=iV is satisfied at the beginning time t6 of the dead time period Td. More specifically, using either the detection result of the load current iV by a current sensor or a signal processing value thereof, or an estimated value of the load current iV, the inductance L of the resonant inductor L1 that has been stored in advance, and the detection result of the potential V15 at the regenerative capacitor 15, for example, the controller 50 determines the additional time Tav by the equation: Tav=iV×(L/V15). In this case, as the detection result of the load current iV or the signal processing value thereof, either a detection value at a carrier cycle at which the additional time Tav is added or a detection value at a timing closest to the carrier cycle may be used. Also, in this case, as the estimated value of the load current iV, a value of the load current iV estimated at the carrier cycle at which the additional time Tav is added may be used, for example.

The additional time Taw is an amount of time that the controller 50 provides to make the high-level period of the control signal SW6 longer than the dead time period Td by setting the beginning time t9 of the high-level period of the control signal SW6 at a point in time earlier than the beginning time t10 of the dead time period Td as shown in FIG. 3. The length of the additional time Taw is determined by the value of the load current iW. To start producing LC resonance from the beginning time t10 of the dead time period Td, it is preferable that the value of the current iL1 agree with the value of the load current iW at the beginning time t10 of the dead time period Td. This is because as long as iL1<iW is satisfied, all of the current iL1 flows through the AC load RA1, and therefore, the resonant capacitor 9W cannot be charged. The end time of the high-level period of the control signal SW6 may be simultaneous with, or later than, the end time t11 of the dead time period Td. In the example shown in FIG. 3, the end time of the high-level period of the control signal SW6 is set to be simultaneous with the end time t11 of the dead time period Td. The controller 50 sets the high-level period of the control signal SW6 at Taw+Td. The voltage V1W across the first switching element 1W goes zero at the end time t11 of the dead time period Td. In the example shown in FIG. 3, the current iL1 starts flowing through the resonant inductor L1 at the beginning time t9 of the high-level period of the control signal SW6 and goes zero at a time t12 when the additional time Taw has passed since the end time t11 of the dead time period Td. As for the current iL1, the current iL1 satisfies iL1≥iW from the beginning time t10 of the dead time period Td and on, and therefore, the current iL1 in the hatched part of the current waveform shown as the fourth waveform from the top of FIG. 3 flows into the resonant capacitor 9W to produce the LC resonance. From the end time t11 of the dead time period Td and on, the current iL1 will be regenerated to the power converter circuit 11 via the third diode 13 directly connected to the resonant inductor L1.

The controller 50 determines the additional time Taw based on the load current iW. More specifically, using the detection result of the load current iW by a current sensor, the inductance L of the resonant inductor L1 that has been stored in advance, and the detection result of the potential V15 at the regenerative capacitor 15, for example, the controller 50 determines the additional time Taw by the equation: Taw=iW×(L/V15). In this case, as the detection result of the load current iW or the signal processing value thereof, either a detection value at a carrier cycle at which the additional time Taw is added or a detection value at a timing closest to the carrier cycle may be used. Also, in this case, as the estimated value of the load current iW, a value of the load current iW estimated at the carrier cycle at which the additional time Taw is added may be used, for example.

### (3.1.2) Operation of Soft-Switching Second Switching Element When Load Current>0

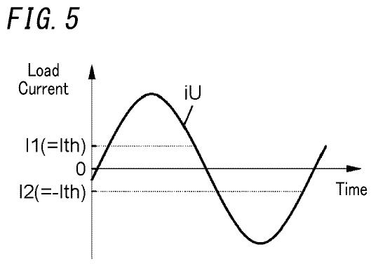

If the target of the soft switching is a second switching element 2 (hereinafter referred to as a “target second switching element 2”) and the polarity of the load current (which is the load current iU, the load current iV, or the load current iW) flowing through the AC terminal 41 connected to the target second switching element 2 is positive, then the controller 50 compares the current value of the load current with a first current threshold value I1 (=Ith, refer to FIG. 5). If the current value of the load current is greater than the first current threshold value I1, the controller 50 does not turn the switch 8 ON. On the other hand, if the current value of the load current is less than the first current threshold value I1, the controller 50 turns the switch 8 ON in the dead time period Td. In the power converter 100, if the current value of the load current is greater than the first current threshold value I1, the controller 50 may perform, using the load current iU, a discharging operation on the resonant capacitor 9U connected to the target second switching element 2 in parallel without turning ON the switch 8 corresponding to the target second switching element 2. This allows the power converter 100 to make zero-voltage soft switching of the target second switching element 2.

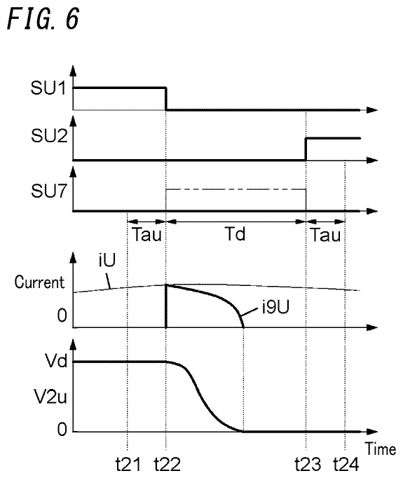

In FIG. 6, the control signals SU1, SU2, SU7, the load current iU, a current i9U flowing from the resonant capacitor 9U, and the voltage V2u across the second switching element 2U are shown as for a situation where the target second switching element 2 is the second switching element 2U of the switching circuit 10U and the current value of the load current is greater than the first current threshold value I1. In addition, the dead time period Td and the additional time Tau set by the controller 50 with respect to a control signal SU7 for the second IGBT 7U of the switch 8U are also shown in FIG. 6.

If the current value of the load current iU is greater than the first current threshold value Il, the controller 50 does not provide any high-level period for the control signal SU7. In that case, in the power converter 100, a current i9U starts flowing from the resonant capacitor 9U at the beginning time t22 of the dead time period Td, the current i9U decreases to zero before the end time t23 of the dead time period Td, and the voltage V2u across the second switching element 2U goes zero before the end time t23 of the dead time period Td. Thus, in the power converter 100, when the control signal SU2 changes from low level to high level at the end time t23 of the dead time period Td, the second switching element 2 is subjected to zero-voltage soft switching.

If the current value of the load current iU is less than the first current threshold value I1, then the controller 50 provides a high-level period for the control signal SU7 as indicated by the two-dot chain in FIG. 6, for example. In that case, the beginning time of the high-level period of the control signal SU7 may be simultaneous with, for example, the beginning time t22 of the dead time period Td. Also, the end time of the high-level period of the control signal SU7 is simultaneous with the end time t23 of the dead time period Td. Thus, in the power converter 100, the voltage V2u across the second switching element 2U goes zero before the end time t23 of the dead time period Td. Consequently, in the power converter 100, when the control signal SU2 changes from low level to high level at the end time t23 of the dead time period Td, the second switching element 2U is subjected to zero-voltage soft switching. Alternatively, the beginning time of the high-level period of the control signal SU7 may be a time t21 which is earlier than the beginning time of the dead time period Td by the additional time Tau. The end time of the high-level period of the control signal SU7 may be a time t24 which is later than the end time t23 of the dead time period Td by the additional time Tau. Note that the time before or after the high-level period overlaps with the dead time period Td does not have to be the additional time Tau but may also be any other preset time.

### (3.1.3) Operation of Making Soft Switching Second Switching Element When Load Current<0

If the polarity of the load current (which is the load current iU, the load current iV, or the load current iW) flowing through the AC terminal 41 connected to the target second switching element 2 is negative, then the controller 50 turns ON the second IGBT 7 corresponding to the target second switching element 2. In this manner, the controller 50 causes the resonant capacitor 9 and the resonant inductor L1 connected to the target second switching element 2 to produce resonance, thereby discharging electricity from the resonant capacitor 9 and reducing the voltage across the target second switching element 2 to zero. This allows the power converter 100 to make zero-voltage soft switching of the target second switching element 2.

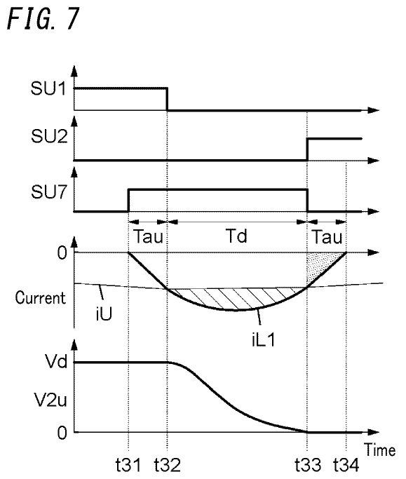

In FIG. 7, the control signals SU1, SU2, SU7, the load current iU, a current iL1 flowing through the resonant inductor L1, and the voltage V2u across the second switching element V2u are shown as for a situation where the target second switching element 2 is the second switching element 2U of the switching circuit 10U.

Furthermore, the dead time period Td that the controller 50 sets to prevent the first switching element 1 and the second switching element 2 of the same phase from turning ON simultaneously is also shown in FIG. 7. Besides, an additional time Tau set by the controller 50 with respect to the control signal SU7 for the second IGBT 7U of the switch 8U is also shown in FIG. 7. The end time of the high-level period of the control signal SU7 may be simultaneous with, or later than, the end time t33 of the dead time period Td. In the example shown in FIG. 7 the end time of the high-level period of the control signal SU7 is set to be simultaneous with the end time t33 of the dead time period Td. The controller 50 sets the high-level period of the control signal SU7 at Tau+Td. In the switching circuit 10U, the voltage V2u across the second switching element 2U goes zero at the end time t33 of the dead time period Td. In the example shown in FIG. 7, the current iL1 starts flowing through the resonant inductor L1 at the beginning time t31 of the high-level period of the control signal SU7 and goes zero at a time t34 when the additional time Tau has passed since the end time t33 of the dead time period Td. As for the current iL1, the current iL1 satisfies iL1≤iU from the beginning time t32 of the dead time period Td, and therefore, LC resonance is produced to cause a resonant current (i.e., a discharging current from the resonant capacitor 9U) to flow from the resonant capacitor 9U toward the resonant inductor L1. From the end time t33 of the dead time period Td and on, the current iL1 will be regenerated to the power converter circuit 11 via the fourth diode 14 directly connected to the resonant inductor L1.

To start producing the LC resonance at the beginning time t32 of the dead time period Td and end a resonant half cycle at the end time t33 of the dead time period Td, the controller 50 determines the additional time Tau based on the load current iU such that iL1=iU is satisfied at the beginning time t32 of the dead time period Td. More specifically, using either the detection result of the output current iU by a current sensor or a signal processing value thereof, or an estimated value of the load current iU, the inductance L of the resonant inductor L1 that has been stored in advance, and the detection result of the potential V15 at the regenerative capacitor 15, for example, the controller 50 determines the additional time Tau by the equation: Tau=|iU|×(L/V15). In this case, as the detection result of the load current iU or the signal processing value thereof, either a detection value at a carrier cycle at which the additional time Tau is added or a detection value at a timing closest to the carrier cycle may be used. Also, in this case, as the estimated value of the load current iU, a value of the load current iU estimated at the carrier cycle at which the additional time Tau is added may be used, for example. The resonant half cycle in the case of the basic operation is one half of a resonant cycle, which is the reciprocal of the resonant frequency of a resonant circuit including the resonant inductor L1 and one resonant capacitor 9. Thus, if the inductance of the resonant inductor L1 is L and the capacitance of the resonant capacitor 9 is C, then the resonant half cycle is π×(L·C)^{1/2}. The controller 50 sets the resonant half cycle in the case of the basic operation to make the resonant half cycle as long as the length of the dead time period Td, for example.

### (3.1.4) Operation of Soft-Switching First Switching Element When Load Current<0

If the polarity of the load current (which is the load current iU, the load current iV, or the load current iW) flowing through the AC terminal 41 connected to the target first switching element 1 is negative, then the controller 50 compares the current value of the load current with a second current threshold value I2 (=−Ith, refer to FIG. 5). If the current value of the load current is less than the second current threshold value I2, the controller 50 does not turn the switch 8 ON. On the other hand, if the current value of the load current is greater than the second current threshold value I2, the controller 50 turns the switch 8 ON in the dead time period Td. In the power converter 100, if the current value of the load current is less than the second current threshold value I2, the controller 50 may charge, using the load current, the resonant capacitor 9U connected to the target first switching element 1 in series without turning ON the switch 8 corresponding to the target first switching element 1. This allows the power converter 100 to make zero-voltage soft switching of the target first switching element 1.

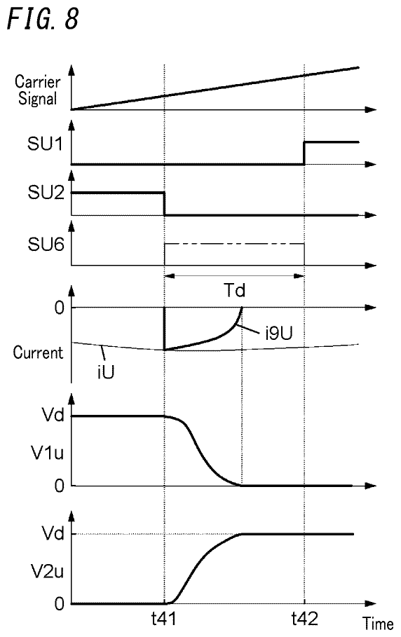

In FIG. 8, the control signals SU1, SU2, SU6, the load current iU, a current i9U flowing from the resonant capacitor 9U, and the voltage V2u across the second switching element 2U are shown as for a situation where the target first switching element 1 is the first switching element 1U of the switching circuit 10U and the current value of the load current is greater than the second current threshold value I2 (in other words, a situation where the absolute value of the current value of the load current is less than the absolute value of the second current threshold value I2). In addition, the dead time period Td is also shown in FIG. 8.

If the current value of the load current is less than the second current threshold value I2 (in other words, if the absolute value of the load current is greater than the absolute value of the second current threshold value I2), the controller 50 does not provide any high-level period for the control signal SU6. In that case, in the power converter 100, a current i9U starts flowing through the resonant capacitor 9U at the beginning time t41 of the dead time period Td. As a result, in the power converter 100, the resonant capacitor 9U is charged with electricity to cause an increase in the voltage V2u across the second switching element 2U. The current i9U goes zero before the end time t23 of the dead time period Td, and the voltage V1u across the first switching element 1 goes zero before the end time t42 of the dead time period Td. Thus, in the power converter 100, when the control signal SU1 changes from low level to high level at the end time t42 of the dead time period Td, the first switching element 1U is subjected to zero-voltage soft switching.

If the current value of the load current is greater than the second current threshold value I2 (in other words, if the absolute value of the load current is less than the absolute value of the second current threshold value), then the controller 50 provides a high-level period for the control signal SU6 as indicated by the two-dot chain in FIG. 8, for example. In that case, the beginning time of the high-level period of the control signal SU6 may be simultaneous with, for example, the beginning time t41 of the dead time period Td. Also, the end time of the high-level period of the control signal SU6 is simultaneous with the end time t42 of the dead time period Td. Thus, in the power converter 100, the voltage V1u across the first switching element 1U goes zero before the end time t42 of the dead time period Td. Consequently, in the power converter 100, when the control signal SU1 changes from low level to high level at the end time t42 of the dead time period Td, the first switching element 1U is subjected to zero-voltage soft switching.

### (3.2) Shift Control Operation

The controller 50 performs, when determining that resonant currents, respectively passing through two or more switches 8 belonging to the plurality of switches 8, be going to flow simultaneously through the resonant inductor L1, shift control of shifting the high-level period of a control signal for at least one of the two or more switches 8 to prevent resonant currents passing through the two or more switches 8 from flowing through the resonant inductor L1 simultaneously. As used herein, the expression “when determining that resonant currents, respectively passing through two switches 8 belonging to the plurality of switches 8, flow simultaneously” refers to a situation where it has been presumed in advance that the resonant currents respectively passing through two or more switches 8 would flow simultaneously through the resonant inductor L1.

### (3.2.1) Determining Whether Two-Phase Resonant Currents Will Flow Simultaneously

In the power converter 100, the phases of three-phase (i.e., U-, V-, and W-phase) voltage instructions are different from each other by 120 degrees, but the instruction values of two-phase voltage instructions approach each other every electrical angle of 60 degrees and the duties of two-phase control signals approach each other (refer to regions A1, A2 shown in FIG. 4). Specifically, in the region A1 shown in FIG. 4, the duty of the U-phase control signal and the duty of the V-phase control signal become around 0.75. In the region A2 shown in FIG. 4, the duty of the U-phase control signal and the duty of the V-phase control signal become around 0.25. The polarity of the resonant current is the same as the polarity of the current iL1. In the region A1, the polarity of the resonant current is positive. In the region A2, the polarity of the resonant current is negative. In the region A1, the time lag between the beginning time t1 (refer to FIG. 2) of the high-level period of the control signal SU6 to be applied to the first IGBT 6U and the beginning time t5 (refer to FIG. 2) of the high-level period of the control signal SV6 to be applied to the first IGBT 6V becomes so short in one cycle time of the carrier signal, for example, that the U-phase resonant current and the V-phase resonant current may be going to flow simultaneously through the resonant inductor L1. In the power converter 100, the direction of the resonant current in the region A2 is reverse from that of the resonant current in the region Al but the U-phase resonant current and the V-phase resonant current may be going to flow simultaneously through the resonant inductor L1.

Supposing the capacitance of each of the plurality of resonant capacitors 9U, 9V, and 9W is C, if a U-phase current and a V-phase current flow simultaneously through the resonant inductor L1, a capacitor having a combined capacitance (=2×C) of the resonant capacitor 9U and the resonant capacitor 9V is connected to the resonant inductor L1 in series in an equivalent circuit. Thus, in the power converter 100, if two-phase currents flowed simultaneously through the resonant inductor L1, then the resonant frequency of a resonant circuit including the resonant inductor L1 would change compared to a situation where a single-phase current flows through the resonant inductor L1. Consequently, the power converter 100 might be unable to make zero-voltage soft switching.

### (3.2.1.1) When Charging Operation is Performed on Resonant Capacitor

FIG. 2 shows an exemplary boundary condition between a situation where the U-phase resonant current and the V-phase resonant current do not overlap with each other (i.e., do not flow simultaneously) and a situation where the U-phase resonant current and the V-phase resonant current overlap with each other (i.e., flow simultaneously). The boundary condition will be described with reference to FIG. 2.

In the power converter 100, if the time lag ΔTuv between the beginning time t3 of the high-level period of the control signal SU1 and the beginning time t7 of the high-level period of the control signal SV1 is equal to or greater than (Tau+Tav+Td), then the U-phase resonant current and the V-phase resonant current do not overlap with each other. On the other hand, if the time lag ΔTuv is less than (Tau+Tav+Td), then the U-phase resonant current and the V-phase resonant current overlap with each other. That is to say, with a threshold value for the time lag ΔTuv set at (Tau+Tav+Td), if the time lag ΔTuv is less than the threshold value, the controller 50 presumes that resonant currents corresponding to the two phases of the switching circuit 10U and the switching circuit 10V belonging to the plurality of switching circuits 10 would flow simultaneously through the resonant inductor L1. Note that this threshold value is only an example, and the threshold value may also be set at any other value. For example, with the error of the additional time Tau and the error of the additional time Tav taken into account, the threshold value may also be set at a value even larger than (Tau+Tav+Td). In addition, the above-described method for calculating the time lag ΔTuv to determine whether the two-phase resonant currents flow simultaneously is only an example. Rather, any other calculating method may also be adopted as long as a time lag corresponding to the time lag described above may be calculated. For example, as the time lag ΔTuv for use to determine whether the two-phase resonant currents flow simultaneously, a time lag between the end time t2 of the high-level period of the control signal SU2 and the end time t6 of the high-level period of the control signal SV2 may also be used.

In the power converter 100, if the time lag between the beginning time t3 of the high-level period of the control signal SU1 and the beginning time t11 of the high-level period of the control signal SW1 is equal to or greater than (Tau+Taw+Td), then the U-phase resonant current and the W-phase resonant current do not overlap with each other. On the other hand, if the time lag is less than (Tau+Taw+Td), then the U-phase resonant current and the W-phase resonant current overlap with each other. That is to say, with a threshold value for the time lag set at (Tau+Taw+Td), if the time lag is less than the threshold value, the controller 50 presumes that resonant currents corresponding to the two phases of the switching circuit 10U and the switching circuit 10W belonging to the plurality of switching circuits 10 would flow simultaneously through the resonant inductor L1. Note that this threshold value is only an example, and the threshold value may also be set at any other value. For example, with the error of the additional time Tau and the error of the additional time Taw taken into account, the threshold value may also be set at a value even larger than (Tau+Taw+Td). In addition, the above-described method for calculating the time lag to determine whether the two-phase resonant currents flow simultaneously is only an example. Rather, any other calculating method may also be adopted as long as a time lag corresponding to the time lag described above may be calculated. For example, as the time lag for use to determine whether the two-phase resonant currents flow simultaneously, a time lag between the end time t2 of the high-level period of the control signal SU2 and the end time t10 of the high-level period of the control signal SW2 may also be used.

In the power converter 100, if the time lag between the beginning time t7 of the high-level period of the control signal SV1 to be applied to the first switching element 1V of the switching circuit 10V and the beginning time t11 of the high-level period of the control signal SW1 to be applied to the first switching element 1W of the switching circuit 10W is equal to or greater than (Tav+Taw+Td), then the V-phase resonant current and the W-phase resonant current do not overlap with each other. On the other hand, if the time lag is less than (Tav+Taw+Td), then the V-phase resonant current and the W-phase resonant current overlap with each other. That is to say, with a threshold value for the time lag set at (Tav+Taw+Td), if the time lag is less than the threshold value, the controller 50 presumes that resonant currents corresponding to the two phases of the switching circuit 10V and the switching circuit 10W belonging to the plurality of switching circuits 10 would flow simultaneously through the resonant inductor L1. Note that this threshold value is only an example, and the threshold value may also be set at any other value. For example, with the error of the additional time Tav and the error of the additional time Taw taken into account, the threshold value may also be set at a value even larger than (Tav+Taw+Td). In addition, the above-described method for calculating the time lag to determine whether the two-phase resonant currents flow simultaneously is only an example. Rather, any other calculating method may also be adopted as long as a time lag corresponding to the time lag described above may be calculated. For example, as the time lag for use to determine whether the two-phase resonant currents flow simultaneously, a time lag between the end time t6 of the high-level period of the control signal SV2 and the end time t10 of the high-level period of the control signal SW2 may also be used.

### (3.2.1.2) When Discharging Operation is Performed on Resonant Capacitor

When performing a discharging operation on the resonant capacitor 9, the controller 50 may also determine, using the same time lag and threshold value as in the case of performing the charging operation on the resonant capacitor 9, whether two-phase resonant currents are going to flow simultaneously.

For example, if the time lag between the beginning time of the high-level period of the control signal SU2 and the beginning time of the high-level period of the control signal SV2 is less than a threshold value (e.g., Tau+Tav+Td), then the controller 50 presumes that the U-phase resonant current and the V-phase resonant current would overlap with each other.

Also, if the time lag between the beginning time of the high-level period of the control signal SU2 and the beginning time of the high-level period of the control signal SW2 is less than a threshold value (e.g., Tau+Taw+Td), then the controller 50 presumes that the U-phase resonant current and the W-phase resonant current would overlap with each other.

Furthermore, if the time lag between the beginning time of the high-level period of the control signal SV2 and the beginning time of the high-level period of the control signal SW2 is less than a threshold value (e.g., Tav+Taw+Td), then the controller 50 presumes that the V-phase resonant current and the W-phase resonant current would overlap with each other.

### (3.2.2) Shift Control to be Performed When Two-Phase Resonant Currents are Determined to Flow Simultaneously

The controller 50 performs shift control of shifting the high-level periods of control signals for the two switches 8 to prevent the resonant currents respectively passing through the two switches 8, for example, from flowing simultaneously through the resonant inductor L1.

While performing the shift control, the controller 50 shifts the high-level periods of control signals for of the two switches 8 to prevent the lengths of the high-level periods of control signals to be applied to the first switching element 1 and the second switching element 2 in each of two switching circuits 10 corresponding to the two switches 8 from changing. For example, when shifting the high-level period of the control signal SU6 or SU7 to be applied to the switch 8U, the controller 50 shifts the respective high-level periods of the control signals SU1, SU2 but does not change the duty of any of the control signals SU1, SU2 in one cycle of the carrier signal. Likewise, when shifting the high-level period of the control signal SV6 or SV7 to be applied to the switch 8V, the controller 50 shifts the respective high-level periods of the control signals SV1, SV2 but does not change the duty of any of the control signals SV1, SV2 in one cycle of the carrier signal. In the same way, when shifting the high-level period of the control signal SW6 or SW7 to be applied to the switch 8W, the controller 50 shifts the respective high-level periods of the control signals SW1, SW2 but does not change the duty of any of the control signals SW1, SW2 in one cycle of the carrier signal. In the following description, in a situation where the high-level period of the control signal SU6 or SU7 for the switch 8U is shifted, the amount of time for which the high-level period of the control signal SU6 or SU7 is shifted (hereinafter referred to as a “shifted time”) will be hereinafter designated by Tus for the sake of convenience of description. Also, in a situation where the high-level period of the control signal SV6 or SV7 for the switch 8V is shifted, the shifted time of the high-level period of the control signal SV6 or SV7 will be hereinafter designated by Tvs. Furthermore, in a situation where the high-level period of the control signal SW6 or SW7 for the switch 8W is shifted, the shifted time of the high-level period of the control signal SW6 or SW7 will be hereinafter designated by Tws.

### (3.2.2.1) Operation of Soft-Switching First Switching Element

When performing the shift control, the controller 50 shifts the respective high-level periods of the control signals for the two switches 8 in mutually different directions. In performing the shift control, first, the controller 50 compares, if the polarity of load currents respectively flowing through two AC terminals 41 connected to the two switch 8 is positive, respective duties of control signals for two first switching elements 1 corresponding to the two switches 8 which belong to the plurality of first switching elements 1. Then, the controller 50 shifts the high-level period of a control signal for a switch 8 corresponding to the first switching element 1, to which a control signal with a relatively large duty is applied, out of the two switches 8 in such a direction as to advance the high-level period of the control signal. On the other hand, the controller 50 shifts the high-level period of a control signal for a switch 8 corresponding to the first switching element 1, to which a control signal with a relatively small duty is applied, out of the two switches 8 in such a direction as to postpone the high-level period of the control signal.

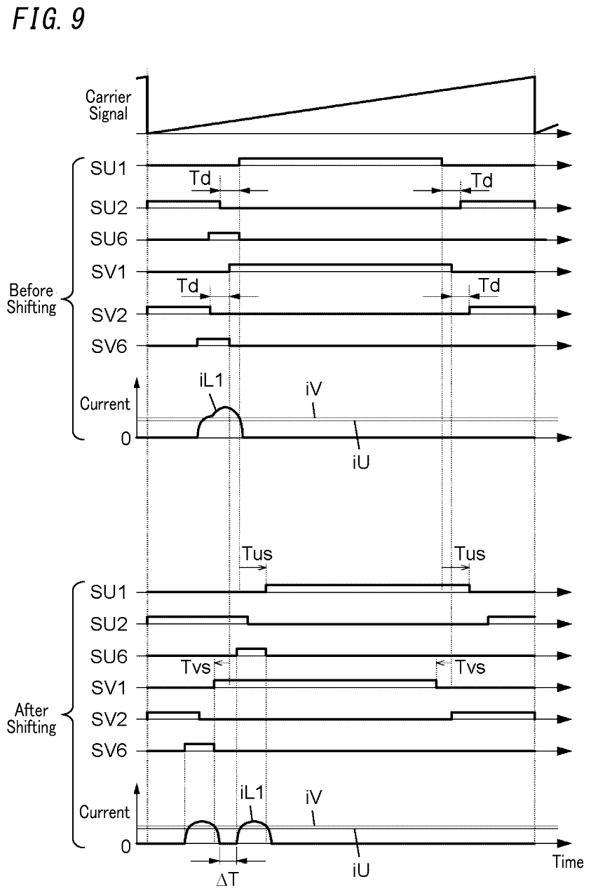

FIG. 9 illustrates how the controller 50 may operate when performing the shift control in a period corresponding to the region Al shown in FIG. 4. The upper part of FIG. 9 is a timing chart showing the waveforms of control signals SU1, SU2, SV1, SV2, control signals SU6, SV6, load currents iU, iV, and a current iL1 before the shift (i.e., in a situation where no shift control is performed) when the controller 50 determines that U- and V-phase currents be going to flow simultaneously. On the other hand, the lower part of FIG. 9 is a timing chart showing the waveforms of the control signals SU1, SU2, SV1, SV2, the control signals SU6, SV6, the load currents iU, iV, and the current iL1 in a situation where the control signals SU6, SV6 are shifted to make the total amount of time shifted, which is the sum of the shifted time of the high-level period of the control signal SU6 and the shifted time of the high-level period of the control signal SV6, equal to a predetermined period. In the example shown in FIG. 9, the controller 50 shifts the beginning time of the high-level period of the control signal SU6 for the switch 8U by a shifted time Tus and shifts the high-level period of the control signal SV6 for the switch 8V by a shifted time Tvs.

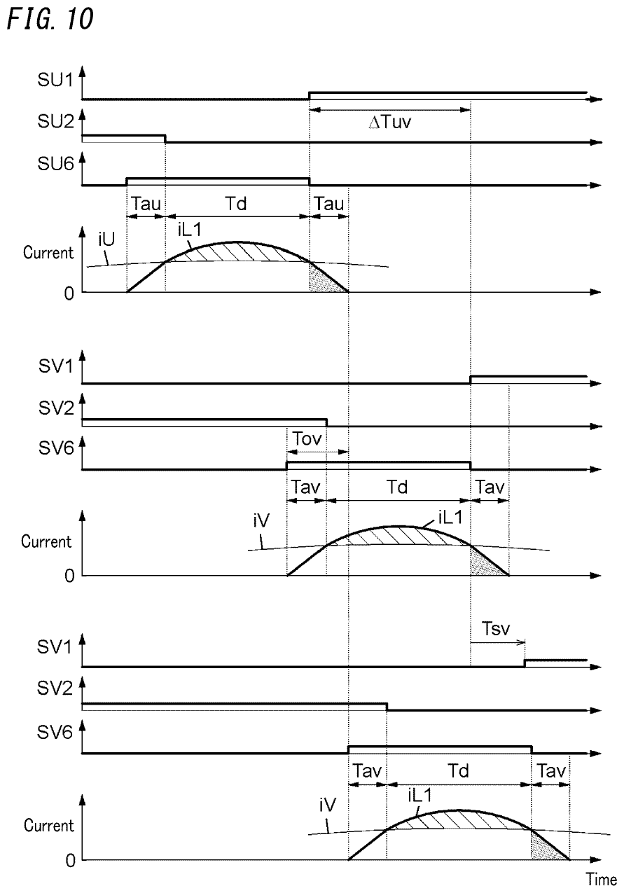

When determining that two-phase resonant currents be going to flow simultaneously, the controller 50 sets the length of the predetermined period at a length equal to or longer than an overlap time Tov of the two-phase resonant currents. The overlap time Tov will be described with reference to FIG. 10. FIG. 10 illustrates the waveforms of resonant currents in a situation where the resonant inductor L1 is not used in common (i.e., in a situation where three resonant inductors L1 corresponding one to one to the three resonant capacitors are provided). The overlap time Tov between the U-phase resonant current (of which the waveform is shown as the fourth waveform from the top of FIG. 10) and the V-phase resonant current (of which the waveform is shown as the eighth waveform from the top of FIG. 10) is calculated by the equation: Tov=(Tau+Tav+Td)−ΔTuv. If the resonant cycle of a resonant circuit formed by the inductance L of the resonant inductor L1 and the capacitance C of one resonant capacitor 9 is Tres, then Tres=1/{2π (L·C)^{1/2}} and Td=Tres/2. The resonant current, of which the waveform is shown as the twelfth waveform from the top of FIG. 10, shows the waveform of a V-phase resonant current when the control signals SV1, SV2, and SV6, of which the waveforms are shown as the fifth, sixth, and seventh ones, respectively, from the top of FIG. 10, are shifted such that their high-level period is postponed by the overlap time Tov. As can be seen from FIG. 10, the resonant current, of which the waveform is shown as the twelfth one from the top of FIG. 10, does not overlap with the resonant current, of which the waveform is shown as the fourth one from the top of FIG. 10. Although FIG. 10 illustrates a situation where the U-phase resonant current and the V-phase resonant current overlap with each other, the overlap time Tov and the shift directions of the control signals may also be determined in the same way even when the U-phase resonant current and the W-phase resonant current overlap with each other and when the V-phase resonant current and the W-phase resonant current overlap with each other.

FIG. 9 illustrates an example in which the controller 50 defines the predetermined period to be Tov+ΔT. That is to say, in the example illustrated in FIG. 9, the controller 50 defines the predetermined period to be Tov+ΔT=Tus+Tvs.

In the example illustrated in FIG. 9, the polarity of the load currents iU, iV flowing through the two AC terminals 41U, 41V connected to the two switches 8U, 8V, respectively, is positive. In that case, the controller 50 compares the respective duties of control signals SU1, SV1 for the two first switching elements 1U, 1V corresponding one to one to the two switches 8U, 8V with each other. The controller 50 shifts the high-level period of the control signal SV6 to be applied to the switch 8V corresponding to the first switching element 1V, to which a control signal SV1 with a relatively large duty is applied, in such a direction as to advance the high-level period of the control signal SV6 by the shifted time Tvs. On the other hand, the controller 50 shifts the high-level period of the control signal SU6 to be applied to the switch 8U corresponding to the first switching element 1U, to which the control signal SU1 with a relatively small duty is applied, in such a direction as to postpone the high-level period of the control signal SU6 by the shifted time Tus.

As can be seen from the waveform of the current iL1 shown in FIG. 9, when the controller 50 determines in advance that two-phase resonant currents, namely, U-phase and V-phase resonant currents, be going to flow simultaneously, the power converter 100 may avoid an overlap between the U-phase resonant current and the V-phase resonant current by performing the shift control (refer to the waveform of the current iL1 in the lower part of FIG. 9). In the same way, when the controller 50 determines in advance that two-phase resonant currents, namely, U-phase and W-phase resonant currents, be going to flow simultaneously, the power converter 100 may avoid an overlap between the U-phase resonant current and the W-phase resonant current by performing the shift control. Also, when the controller 50 determines in advance that two-phase resonant currents, namely, V-phase and W-phase resonant currents, be going to flow simultaneously, the power converter 100 may avoid an overlap between the V-phase resonant current and the W-phase resonant current by performing the shift control. Note that the upper limit value (maximum value) of the shifted time in a situation where the control signal for the switch 8 has its high-level period shifted to be advanced is a shifted time in a situation where the time lag between the beginning time of one cycle of a carrier signal and the beginning time of the high-level period of the shifted control signal (i.e., the control signal for the switch 8 which has been shifted) becomes equal to a minimum value (of zero, for example) without changing the length of the high-level period. On the other hand, the upper limit value (maximum value) of the shifted time in a situation where the control signal for the switch 8 has its high-level period shifted to be postponed is a shifted time in a situation where the time lag between the end time of one cycle of a carrier signal and the end time of the high-level period of the shifted control signal (i.e., the control signal for the switch 8 which has been shifted) becomes equal to a minimum value (of zero, for example) without changing the length of the high-level period.

In the power converter 100, if the controller 50 does not perform the shift control, the voltages V2u, V2v across the second switching elements 2U, 2V do not rise to Vd at a point in time when the control signals SU1, SV1 make a transition from a low-level period to a high-level period (i.e., the end time of the dead time period Td corresponding to each of U- and V-phases). That is to say, if the controller 50 does not perform the shift control, the resonant capacitors 9U, 9V have not been charged with electricity yet at the end time of the dead time period Td corresponding to each of U- and V-phases. Therefore, if the controller 50 does not perform the shift control, then none of the voltages across the first switching elements 1U, 1V decreases to zero at the end time of the dead time period Td corresponding to each of U- and V-phases. Consequently, in the power converter 100, the first switching elements 1U, 1V are hard-switched.

On the other hand, if the controller 50 has performed the shift control, the voltages V2u, V2v across the second switching elements 2U, 2V rise to Vd at a point in time when the control signals SU1, SV1 make a transition from a low-level period to a high-level period (i.e., the end time of the dead time period Td corresponding to each of U- and V-phases) as shown in FIG. 9. That is to say, if the controller 50 has performed the shift control, then the resonant capacitors 9U, 9V have already been charged with electricity at the end time of the dead time period Td corresponding to each of U- and V-phases. Therefore, in the power converter 100, if the controller 50 has performed the shift control, the first switching elements 1U, 1V are switched by zero-voltage soft switching.

FIG. 9 illustrates how the shift control may be performed in a situation where the controller 50 has determined in advance that a U-phase resonant current and a V-phase resonant current be going to flow simultaneously through the resonant inductor L1. However, this is only an example and should not be construed as limiting. For example, even if the controller 50 has determined in advance that a V-phase resonant current and a W-phase resonant current be going to flow simultaneously through the resonant inductor L1 and even if the controller 50 has determined in advance that a W-phase resonant current and a U-phase resonant current be going to flow simultaneously through the resonant inductor L1, zero-voltage soft switching may also be made by making the controller 50 perform the shift control.

### (3.2.2.2) Operation of Soft-Switching Second Switching Element

When performing the shift control, the controller 50 shifts the respective high-level periods of the control signals for the two switches 8 in mutually different directions. In performing the shift control, first, the controller 50 compares, if the polarity of load currents respectively flowing through two AC terminals 41 connected to the two switch 8 is negative, respective duties of control signals for the two first switching elements 1 corresponding to the two switches 8 which belong to the plurality of first switching elements 1. Then, the controller 50 shifts the high-level period of a control signal for a switch 8, corresponding to the first switching element 1, to which a control signal with a relatively large duty is applied, out of the two switches 8 in such a direction as to postpone the high-level period of the control signal. On the other hand, the controller 50 shifts the high-level period of a control signal for a switch 8 corresponding to the first switching element 1, to which a control signal with a relatively small duty is applied, out of the two switches 8 in such a direction as to advance the high-level period of the control signal.

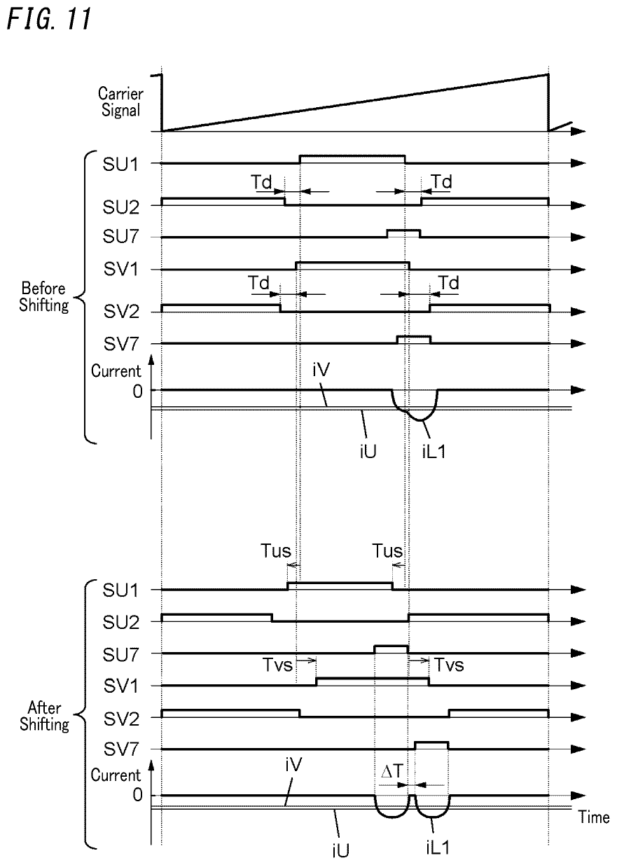

FIG. 11 illustrates how the controller 50 may operate when performing the shift control in a period corresponding to the region A2 shown in FIG. 4. The upper part of FIG. 11 is a timing chart showing the waveforms of control signals SU1, SU2, SV1, SV2, control signals SU7, SV7, load currents iU, iV, and a current iL1 before the shift (i.e., in a situation where no shift control is performed) when the controller 50 has determined that two-phase resonant currents, namely, U- and V-phase currents, be going to flow simultaneously. On the other hand, the lower part of FIG. 11 is a timing chart showing the waveforms of the control signals SU1, SU2, SV1, SV2, the control signals SU7, SV7, the load currents iU, iV, and the current iL1 in a situation where the control signals SU7, SV7 are shifted to make the total amount of time shifted, which is the sum of the shifted time of the high-level period of the control signal SU7 and the shifted time of the high-level period of the control signal SV7, equal to a predetermined period. In the example shown in FIG. 11, the controller 50 shifts the beginning time of the high-level period of the control signal SU7 for the switch 8U by a shifted time Tus and shifts the high-level period of the control signal SV7 for the switch 8V by a shifted time Tvs.

When determining that two-phase resonant currents be going to flow simultaneously, the controller 50 sets the length of the predetermined period at a length equal to or longer than an overlap time Tov of the two-phase resonant currents.

FIG. 11 illustrates an example in which the controller 50 defines the predetermined period to be Tov+AT. That is to say, in the example illustrated in FIG. 11, the controller 50 defines the predetermined period to be Tov+ΔT=Tus+Tvs.

In the example illustrated in FIG. 11, the polarity of the load currents iU, iV flowing through the two AC terminals 41U, 41V connected to the two switches 8U, 8V, respectively, is negative. In that case, the controller 50 compares the respective duties of control signals SU1, SV1 for the two first switching elements 1U, 1V corresponding one to one to the two switches 8U, 8V with each other. The controller 50 shifts the high-level period of the control signal SV7 to be applied to the switch 8V corresponding to the first switching element 1V, to which a control signal SV1 with a relatively large duty is applied, in such a direction as to postpone the high-level period of the control signal SV7 by the shifted time Tvs. On the other hand, the controller 50 shifts the high-level period of the control signal SU7 to be applied to the switch 8U corresponding to the first switching element 1U, to which the control signal SU1 with a relatively small duty is applied, in such a direction as to advance the high-level period of the control signal SU7 by the shifted time Tus.

As can be seen from the waveform of the current iL1 shown in FIG. 11, when the controller 50 has determined in advance that two-phase resonant currents, namely, U-phase and V-phase resonant currents, be going to flow simultaneously, the power converter 100 may avoid an overlap between the U-phase resonant current and the V-phase resonant current by performing the shift control (refer to the waveform of the current iL1 in the lower part of FIG. 11). In the same way, when the controller 50 has determined in advance that two-phase resonant currents, namely, U-phase and W-phase resonant currents, be going to flow simultaneously, the power converter 100 may avoid an overlap between the U-phase resonant current and the W-phase resonant current by performing the shift control. Furthermore, when the controller 50 has determined in advance that two-phase resonant currents, namely, V-phase and W-phase resonant currents, be going to flow simultaneously, the power converter 100 may avoid an overlap between the V-phase resonant current and the W-phase resonant current by performing the shift control.

In the power converter 100, if the controller 50 does not perform the shift control, the voltages V1u, V1v across the first switching elements 1U, 1V do not rise to Vd at a point in time when the control signals SU2, SV2 make a transition from a low-level period to a high-level period (i.e., the end time of the dead time period Td corresponding to each of U- and V-phases). That is to say, if the controller 50 does not perform the shift control, the resonant capacitors 9U, 9V have not been charged with electricity yet at the end time of the dead time period Td corresponding to each of U- and V-phases. Therefore, if the controller 50 does not perform the shift control, then none of the voltages across the second switching elements 2U, 2V decreases to zero at the end time of the dead time period Td corresponding to each of U- and V-phases. Consequently, in the power converter 100, the second switching elements 2U, 2V are hard-switched.

On the other hand, if the controller 50 has performed the shift control, the voltages V1u, V1v across the first switching elements 1U, 1V rise to Vd at a point in time when the control signals SU2, SV2 make a transition from a low-level period to a high-level period (i.e., the end time of the dead time period Td corresponding to each of U- and V-phases) as shown in FIG. 11. That is to say, if the controller 50 has performed the shift control, then electricity has already been discharged from the resonant capacitors 9U, 9V at the end time of the dead time period Td corresponding to each of U- and V-phases. Therefore, in the power converter 100, if the controller 50 has performed the shift control, the second switching elements 2U, 2V are switched by zero-voltage soft switching.

FIG. 11, which has already been referred to above, illustrates how the shift control may be performed in a situation where the controller 50 has determined in advance that a U-phase resonant current and a V-phase resonant current be going to flow simultaneously through the resonant inductor L1. However, this is only an example and should not be construed as limiting. For example, even if the controller 50 has determined in advance that a V-phase resonant current and a W-phase resonant current be going to flow simultaneously through the resonant inductor L1 and even if the controller 50 has determined in advance that a W-phase resonant current and a U-phase resonant current be going to flow simultaneously through the resonant inductor L1, zero-voltage soft switching may also be made by making the controller 50 perform the shift control.

### (4) Recapitulation

In the power converter 100 according to the first embodiment, when determining that resonant currents passing respectively through two switches 8 belonging to the plurality of switches 8 be going to flow simultaneously through the resonant inductor L1, the controller 50 performs the control of shifting the high-level period of a control signal for each of the two switches 8 to prevent the resonant currents passing respectively through the two switches 8 from flowing simultaneously through the resonant inductor L1. This allows the power converter 100 to make soft switching with more reliability.

Also, in the power converter 100 according to the first embodiment, when performing the shift control, the controller 50 shifts the high-level period of a control signal for each of the two switches 8 to prevent the high-level periods of control signals to be applied to the first switching element 1 and the second switching element 2 of one switching circuit 10 connected to the two switches 8 which belongs to the plurality of switching circuits 10 from changing their length. This allows the power converter 100 according to the first embodiment to reduce a variation in line voltage.

In addition, in the power converter 100 according to the first embodiment, when performing the shift control, the controller 50 shifts respective high-level periods of control signals for the two switches 8 in mutually different directions. This allows the power converter 100 according to the first embodiment to contribute to increasing the operating frequency.

Furthermore, in the power converter 100 according to the first embodiment, when performing the shift control, if the polarity of load currents respectively flowing through two AC terminals 41 connected to the two switch 8 is positive, the controller 50 compares respective duties of control signals for two first switching elements 1 corresponding to the two switches 8. Then, the controller 50 shifts a high-level period of a control signal to be applied to a switch 8 corresponding to the first switching element 1, to which a control signal with a relatively large duty is applied, in such a direction as to advance the high-level period of the control signal. On the other hand, the controller 50 shifts a high-level period of a control signal to be applied to a switch 8 corresponding to the first switching element 1, to which a control signal with a relatively small duty is applied, in such a direction as to postpone the high-level period of the control signal. If the polarity of the load currents respectively flowing through the two AC terminals 41 connected to the two switches 8 is negative, then the controller 50 compares the respective duties of the control signals for the two first switching elements 1 corresponding to the two switches 8. Then, the controller 50 shifts the high-level period of the control signal to be applied to the switch 8 corresponding to the first switching element 1, to which the control signal with the relatively large duty is applied, in such a direction as to postpone the high-level period of the control signal and shifts the high-level period of the control signal to be applied to the switch 8 corresponding to the first switching element 1, to which the control signal with the relatively small duty is applied, in such a direction as to advance the high-level period of the control signal. This allows the power converter 100 according to the first embodiment to contribute to increasing the operating frequency.

### Second Embodiment

A power converter 100 according to a second embodiment has the same circuit configuration as the power converter 100 according to the first embodiment (refer to FIG. 1) described above, and therefore, illustration and description thereof will be omitted herein.

In the power converter 100 according to the second embodiment, when determining that two-phase resonant currents be going to overlap with each other, the controller 50 performs the shift control in a different manner from the controller 50 according to the first embodiment.

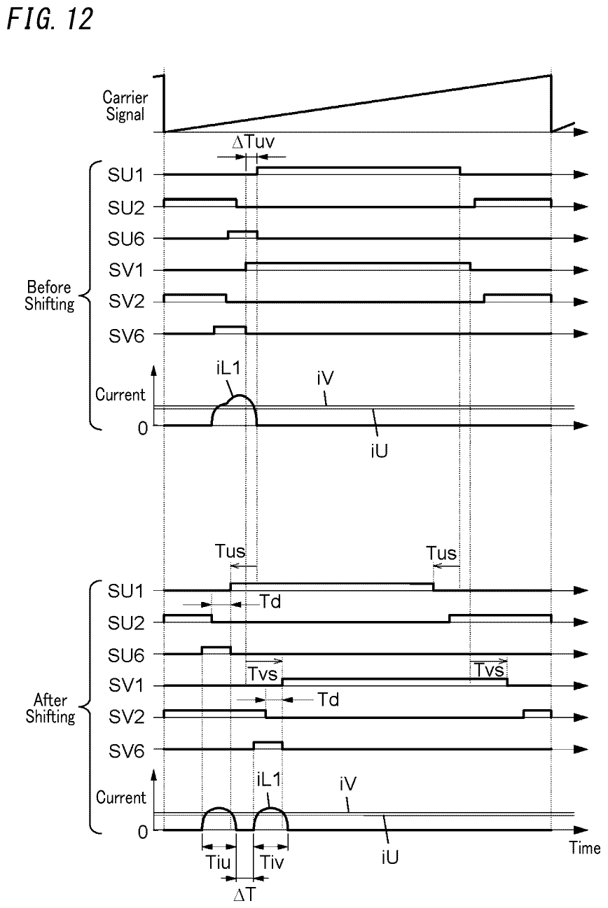

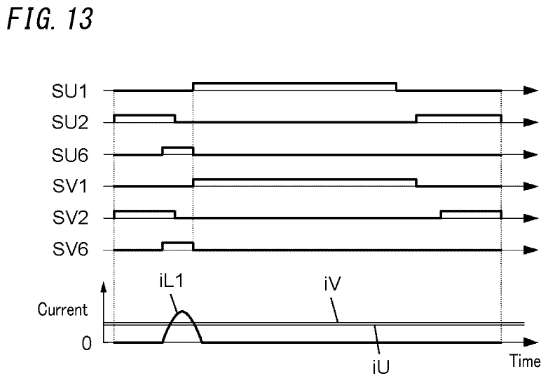

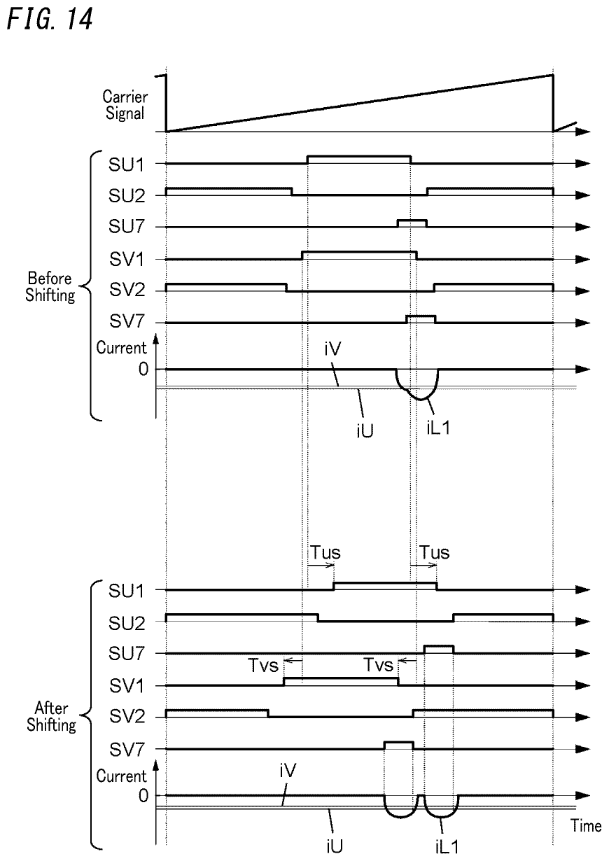

In the following description, it will be described with reference to FIGS. 12 and 13 how the controller 50 operates, when determining that two-phase resonant currents be going to flow simultaneously through the resonant inductor L1, to make soft switching of the first switching elements 1. It will be described with reference to FIG. 14 how the controller 50 operates, when determining that two-phase resonant currents be going to flow simultaneously through the resonant inductor L1, to make soft switching of the second switching elements 2.

### (1.1) Operation of Soft-Switching First Switching Elements

When performing the shift control, the controller 50 shifts the respective high-level periods of the control signals for the two switches 8 in mutually different directions. In performing the shift control, first, the controller 50 compares, if the polarity of load currents respectively flowing through two AC terminals 41 connected to the two switch 8 is positive, respective duties of control signals for two first switching elements 1 corresponding to the two switches 8 which belong to the plurality of first switching elements 1. Then, the controller 50 shifts the high-level period of a control signal to be applied to a switch 8 corresponding to the first switching element 1, to which a control signal with a relatively large duty is applied, in such a direction as to postpone the high-level period of the control signal. On the other hand, the controller 50 shifts the high-level period of a control signal to be applied to a switch 8 corresponding to the first switching element 1, to which a control signal with a relatively small duty is applied, in such a direction as to advance the high-level period of the control signal.

FIG. 12 illustrates how the controller 50 may operate when performing the shift control in a period corresponding to the region Al shown in FIG. 4. The upper part of FIG. 12 is a timing chart showing the waveforms of control signals SU1, SU2, SV1, SV2, control signals SU6, SV6, load currents iU, iV, and a current iL1 before the shift (i.e., in a situation where no shift control is performed) when the controller 50 has determined that two-phase resonant currents, namely, U- and V-phase resonant currents, flow simultaneously. On the other hand, the lower part of FIG. 12 is a timing chart showing the waveforms of the control signals SU1, SU2, SV1, SV2, the control signals SU6, SV6, the load currents iU, iV, and the current iL1 in a situation where the control signals SU6, SV6 are shifted to make the total amount of time shifted, which is the sum of the time shifted time of the high-level period of the control signal SU6 and the shifted time of the high-level period of the control signal SV6, equal to a predetermined period. In the example shown in FIG. 12, the controller 50 shifts the beginning time of the high-level period of the control signal SU6 for the switch 8U by a shifted time Tus and shifts the high-level period of the control signal SV6 for the switch 8V by a shifted time Tvs.

Supposing a resonant current time is Ti and a time margin is ΔT, the controller 50 defines the predetermined period to be ΔTuv+Ti+ΔT. If the additional time for the high-level period of one switch 8 connected to the AC terminal 41 having a load current with the larger absolute value which belong to the two switches 8 is Ta, the resonant current time Ti is calculated by the equation: 2×Ta+Tres/2. FIG. 12 shows a resonant current time Tiu of the U-phase and a resonant current time Tiv of the V-phase. In the example shown in FIG. 12, the absolute value of the V-phase load current iV is larger than the absolute value of the U-phase load current iU, and therefore, the resonant current time Ti is supposed to be the V-phase resonant current time Tiv and the additional time Ta is supposed to be the additional time Tav for the high-level period of the switch 8V. Although FIG. 12 illustrates a situation where the U-phase resonant current and the V-phase resonant current overlap with each other, the predetermined period and the shift directions of the control signals may also be determined in the same way even when the U-phase resonant current and the W-phase resonant current overlap with each other and when the V-phase resonant current and the W-phase resonant current overlap with each other.

In the example illustrated in FIG. 12, the controller 50 defines the predetermined period to be ΔTuv+(2×Tav+Tres/2)+ΔT. That is to say, in the example illustrated in FIG. 12, the controller 50 defines the predetermined period to be ΔTuv+(2×Tav+Tres/2)+ΔT.

In the example illustrated in FIG. 12, the polarity of the load currents iU, iV flowing through the two AC terminals 41U, 41V connected to the two switches 8U, 8V, respectively, is positive. In that case, the controller 50 compares the respective duties of control signals SU1, SV1 for the two first switching elements 1U, 1V corresponding one to one to the two switches 8U, 8V with each other. The controller 50 shifts the high-level period of the control signal SV6 to be applied to the switch 8V corresponding to the first switching element 1V, to which a control signal SV1 with a relatively large duty is applied, in such a direction as to postpone the high-level period of the control signal SV6 by the shifted time Tvs. On the other hand, the controller 50 shifts the high-level period of the control signal SU6 to be applied to the switch 8U corresponding to the first switching element 1U, to which the control signal SU1 with a relatively small duty is applied, in such a direction as to advance the high-level period of the control signal SU6 by the shifted time Tus. Note that FIG. 13 shows that if the end time of the high-level period of the control signal SU6 and the end time of the high-level period of the control signal SV6 are synchronized with each other, the U-phase resonant current and the V-phase resonant current overlap with each other, supposing the total amount of time that is the sum of the shifted time, by which the high-level period of the control signal SU6 is shifted in such a direction as to advance the high-level period thereof, and the shifted time, by which the high-level period of the control signal SV6 is shifted in such a direction as to postpone the high-level period thereof, is ΔTuv.

As can be seen from the waveform of the current iL1 shown in FIG. 12, when the controller 50 has determined in advance that two-phase resonant currents, namely, U-phase and V-phase resonant currents, be going to flow simultaneously, the power converter 100 may avoid an overlap between the U-phase resonant current and the V-phase resonant current by performing the shift control (refer to the waveform of the current iL1 in the lower part of FIG. 12). In the same way, when the controller 50 has determined in advance that two-phase resonant currents, namely, U-phase and W-phase resonant currents, be going to flow simultaneously, the power converter 100 may avoid an overlap between the U-phase resonant current and the W-phase resonant current by performing the shift control. When the controller 50 has determined that two-phase resonant currents, namely, V-phase and W-phase resonant currents, be going to flow simultaneously, the power converter 100 may avoid an overlap between the V-phase resonant current and the W-phase resonant current by performing the shift control. Note that the upper limit value (maximum value) of the shifted time in a situation where the control signal for the switch 8 has its high-level period shifted to be postponed is a shifted time in a situation where the time lag between the end time of one cycle of a carrier signal and the end time of the high-level period of the shifted control signal (i.e., the control signal for the switch 8 which has been shifted) becomes equal to zero. On the other hand, the upper limit value (maximum value) of the shifted time in a situation where the control signal for the switch 8 has its high-level period shifted to be advanced is a shifted time in a situation where the time lag between the beginning time of one cycle of a carrier signal and the beginning time of the high-level period of the shifted control signal (i.e., the control signal for the switch 8 which has been shifted) becomes equal to zero.

In the power converter 100 according to the second embodiment, if the controller 50 has performed the shift control by determining that two-phase resonant currents be going to flow simultaneously through the resonant inductor L1, an overlap between resonant currents may be avoided as shown in FIG. 12. Thus, at the end time of the dead time period Td corresponding to each of the U- and V-phases, the resonant capacitors 9U, 9V have already been charged with electricity. Therefore, in the power converter 100, if the controller 50 has performed the shift control, the first switching elements 1U, 1V are switched by zero-voltage soft switching.

FIG. 12, which has already been referred to above, illustrates how the shift control may be performed in a situation where the controller 50 has determined in advance that a U-phase resonant current and a V-phase resonant current be going to flow simultaneously through the resonant inductor L1. However, this is only an example and should not be construed as limiting. For example, even if the controller 50 has determined in advance that a V-phase resonant current and a W-phase resonant current be going to flow simultaneously through the resonant inductor L1 and even if the controller 50 has determined in advance that a W-phase resonant current and a U-phase resonant current be going to flow simultaneously through the resonant inductor L1, zero-voltage soft switching may also be made by making the controller 50 perform the shift control.

### (1.2) Operation of Soft-Switching Second Switching Elements

When performing the shift control, the controller 50 shifts the respective high-level periods of the control signals for the two switches 8 in mutually different directions. In performing the shift control, first, the controller 50 compares, if the polarity of load currents respectively flowing through two AC terminals 41 connected to the two switch 8 is negative, respective duties of control signals for two first switching elements 1 corresponding to the two switches 8 which belong to the plurality of first switching elements 1. Then, the controller 50 shifts the high-level period of a control signal to be applied to a switch 8 corresponding to the first switching element 1, to which a control signal with a relatively large duty is applied, out of the two switches 8 in such a direction as to advance the high-level period of the control signal. On the other hand, the controller 50 shifts the high-level period of a control signal to be applied to a switch 8 corresponding to the first switching element 1, to which a control signal with a relatively small duty is applied, out of the two switches 8 in such a direction as to postpone the high-level period of the control signal.

FIG. 14 illustrates how the controller 50 may operate when performing the shift control in a period corresponding to the region A2 shown in FIG. 4. The upper part of FIG. 14 is a timing chart showing the waveforms of control signals SU1, SU2, SV1, SV2, control signals SU7, SV7, load currents iU, iV, and a current iL1 before the shift (i.e., in a situation where no shift control is performed) when the controller 50 has determined that two-phase resonant currents, namely, U- and V-phase resonant currents, flow simultaneously. On the other hand, the lower part of FIG. 14 is a timing chart showing the waveforms of the control signals SU1, SU2, SV1, SV2, the control signals SU7, SV7, the load currents iU, iV, and the current iL1 in a situation where the control signals SU7, SV7 are shifted to make the total amount of time shifted, which is the sum of the shifted time of the high-level period of the control signal SU7 and the shifted time of the high-level period of the control signal SV7, equal to a predetermined period. In the example shown in FIG. 14, the controller 50 shifts the beginning time of the high-level period of the control signal SU7 for the switch 8U by a shifted time Tus and shifts the high-level period of the control signal SV7 for the switch 8V by a shifted time Tvs.

In the example illustrated in FIG. 14, the controller 50 defines the predetermined period to be ΔTuv+(2×Tau+Tres/2)+ΔT.

In the example illustrated in FIG. 14, the polarity of the load currents iU, iV flowing through the two AC terminals 41U, 41V connected to the two switches 8U, 8V, respectively, is negative. In that case, the controller 50 compares the respective duties of control signals SU1, SV1 for the two first switching elements 1U, 1V corresponding one to one to the two switches 8U, 8V with each other. The controller 50 shifts the high-level period of the control signal SV7 to be applied to the switch 8V corresponding to the first switching element 1V, to which a control signal SV1 with a relatively large duty is applied, in such a direction as to advance the high-level period of the control signal SV7 by the shifted time Tvs. On the other hand, the controller 50 shifts the high-level period of the control signal SU7 to be applied to the switch 8U corresponding to the first switching element 1U, to which the control signal SU1 with a relatively small duty is applied, in such a direction as to postpone the high-level period of the control signal SU7 by the shifted time Tus.

As can be seen from the waveform of the current iL1 shown in FIG. 14, when the controller 50 has determined in advance that two-phase resonant currents, namely, U-phase and V-phase resonant currents, be going to flow simultaneously, the power converter 100 may avoid an overlap between the U-phase resonant current and the V-phase resonant current by performing the shift control (refer to the waveform of the current iL1 in the lower part of FIG. 14). In the same way, when the controller 50 has determined in advance that two-phase resonant currents, namely, U-phase and W-phase resonant currents, be going to flow simultaneously, the power converter 100 may avoid an overlap between the U-phase resonant current and the W-phase resonant current by performing the shift control. Furthermore, when the controller 50 has determined that two-phase resonant currents, namely, V-phase and W-phase resonant currents, be going to flow simultaneously, the power converter 100 may avoid an overlap between the V-phase resonant current and the W-phase resonant current by performing the shift control.

In the power converter 100, if the controller 50 has performed the shift control, electricity has been discharged from the resonant capacitors 9U, 9V at point in time when the control signals SU2, SV2 make a transition from the low-level period to the high-level period (i.e., at the end time of the dead time period Td corresponding to each of the U- and V-phases) as shown in FIG. 14. Therefore, in the power converter 100, if the controller 50 has performed the shift control, the second switching elements 2U, 2V are switched by zero-voltage soft switching.

FIG. 14, which has already been referred to above, illustrates how the shift control may be performed in a situation where the controller 50 has determined in advance that a U-phase resonant current and a V-phase resonant current be going to flow simultaneously through the resonant inductor L1. However, this is only an example and should not be construed as limiting. For example, even if the controller 50 has determined in advance that a V-phase resonant current and a W-phase resonant current be going to flow simultaneously through the resonant inductor L1 and even if the controller 50 has determined in advance that a W-phase resonant current and a U-phase resonant current be going to flow simultaneously through the resonant inductor L1, zero-voltage soft switching may also be made by making the controller 50 perform the shift control.

### Variation of Second Embodiment

In the power converter 100 according to a variation of the second embodiment, the controller 50 is configured to perform the shift control of the controller 50 according to the second embodiment and the shift control of the controller 50 according to the first embodiment either alternately or at an arbitrary ratio by combining the shift control of the controller 50 according to the second embodiment and the shift control of the controller 50 according to the first embodiment. This allows the power converter 100 according to this variation to reduce the bias of a ripple variation of the line voltage more significantly than the power converter 100 according to the first embodiment or the power converter 100 according to the second embodiment. In addition, the power converter 100 according to this variation may have the period during which the resonant current flows through the resonant inductor L1 distributed more broadly than the power converter 100 according to the first embodiment or the power converter 100 according to the second embodiment, thus allowing for lightening the thermal load on the resonant inductor L1.

### Third Embodiment

A power converter 100 according to a third embodiment has the same circuit configuration as the power converter 100 according to the first embodiment (refer to FIG. 1) described above, and therefore, illustration and description thereof will be omitted herein.

In the power converter 100 according to the third embodiment, the shift control operation performed by the controller 50 that has determined that three-phase resonant currents be going to overlap with each other is different from the shift control operation performed by the controller 50 according to the first embodiment.

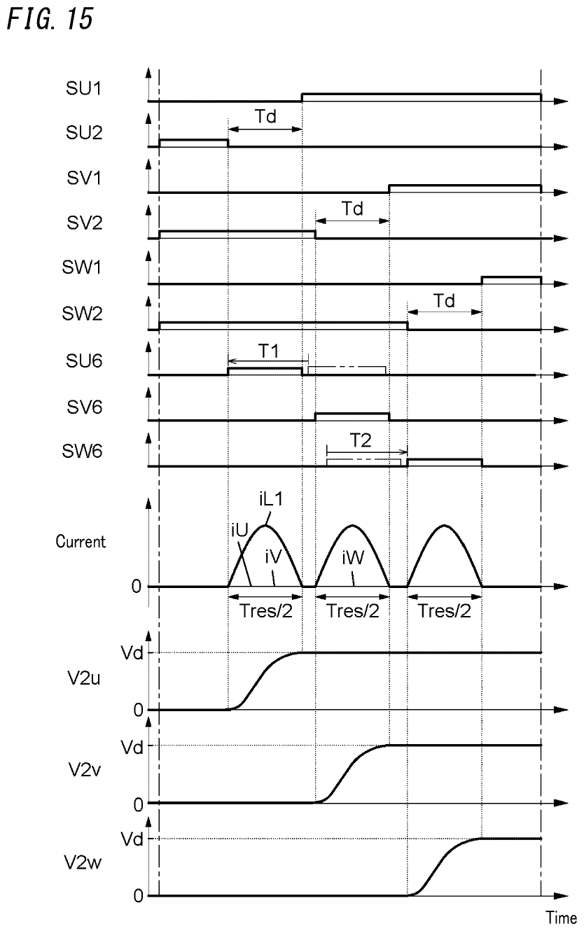

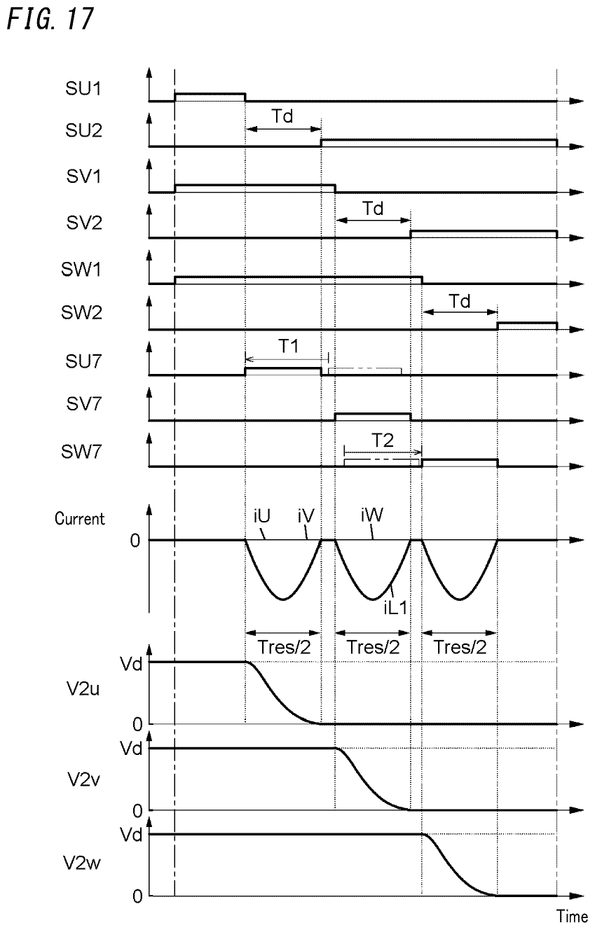

Next, it will be described with reference to FIGS. 15 and 17 how the controller 50 operates when determining that resonant currents respectively passing through three switches 8 belonging to the plurality of switches 8 be going to flow simultaneously through the resonant inductor L1. When determining that the resonant currents respectively passing through three switches 8 belonging to the plurality of switches 8 be going to flow simultaneously through the resonant inductor L1, the controller 50 performs the shift control operation. As used herein, the expression “when determining that the resonant currents respectively passing through three switches 8 belonging to the plurality of switches 8 flow simultaneously” refers to a situation where it has been presumed in advance that the resonant currents respectively passing through the three switches 8 would be going to flow simultaneously through the resonant inductor L1. The three-phase resonant currents are supposed to overlap with each other in a situation where the status of the AC load RA1 is a light load and iU=0, iV=0, and iW=0. Such a state arises, for example, when the AC load RA1 is a motor, particularly when the motor is running at low velocities or when the rotational velocity of the motor is zero (e.g., when the motor is locked). Thus, when the rotational velocity (e.g., number of revolutions [rpm]) of the motor is less than a rotational velocity threshold value, for example, the controller 50 determines that three-phase resonant currents be going to flow simultaneously. In this case, the controller 50 determines that three-phase resonant currents be going to flow simultaneously, for example, if the rotational velocity determined by calculation, or estimated, based on sensor information provided by a sensor device (such as an encoder or a resolver) for detecting the number of revolutions of the motor is less than the rotational velocity threshold value.

Supposing the capacitance of each of the plurality of resonant capacitors 9U, 9V, and 9W is C, if a U-phase current, a V-phase current, and a W-phase current flow simultaneously through the resonant inductor L1, a capacitor having a combined capacitance (=3×C) of the resonant capacitor 9U, the resonant capacitor 9V, and the resonant capacitor 9W is connected to the resonant inductor L1 in series in an equivalent circuit. Thus, in the power converter 100, if three-phase currents flow simultaneously through the resonant inductor L1, then the resonant frequency of a resonant circuit including the resonant inductor L1 changes compared to a situation where a single-phase current flows through the resonant inductor L1. Consequently, the power converter 100 could be unable to make zero-voltage soft switching.

When determining that resonant currents respectively passing through the three switches 8 be going to flow simultaneously through the resonant inductor L1, the controller 50 performs the shift control of shifting the respective high-level periods of control signals for two switches 8 out of the three switches 8 to prevent the resonant currents respectively passing through the three switches 8 from flowing through the resonant inductor L1 simultaneously.

Also, when performing the shift control, the controller 50 shifts the respective high-level periods of the control signals for the two switches 8 to prevent the length of the respective high-level periods of the control signals to be applied to the first switching element 1 and second switching element 2 of one switching circuit 10 connected to the two switches 8 which belong to the plurality of switching circuits 10 from changing.

Furthermore, when performing the shift control, the controller 50 selects control signals for any two switches 8 as the target of shifting from the control signals for the three switches 8 and shifts the respective high-level periods of the control signals for the two switches 8 as the target of shifting in mutually different directions to prevent the resonant currents respectively passing through the three switches 8 from flowing simultaneously through the resonant inductor L1.

### (1) Operation of Power Converter

### (1.1) Basic Operation

The basic operation of the controller 50 is the same as the one already described for the first embodiment, and therefore, description thereof will be omitted herein.

### (1.2) Shift Control

### (1.2.1) Operation of Soft-Switching First Switching Element

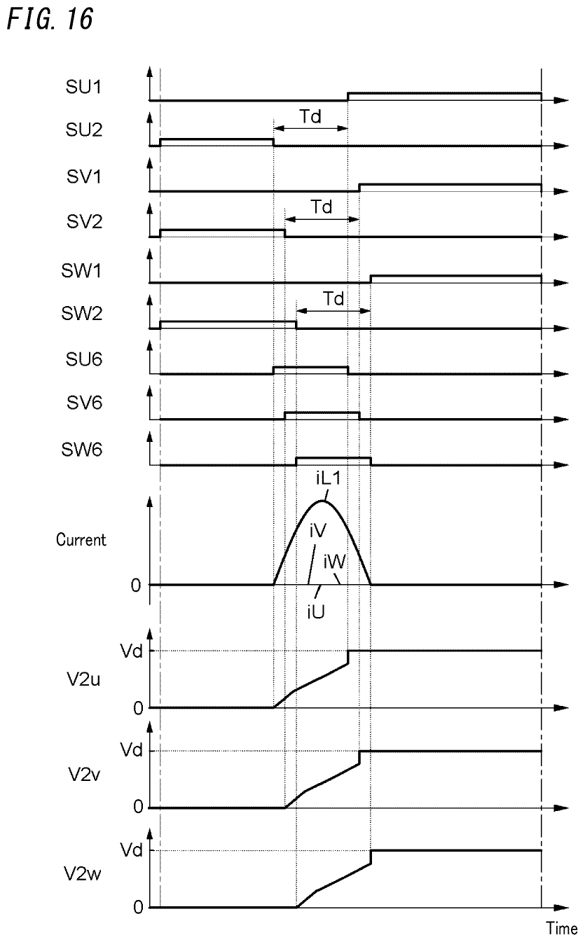

FIG. 15 is a timing chart illustrating how the power converter 100 operates when the controller 50 has determined that three-phase resonant currents, namely, the U-, V-, and W-phase resonant currents, be going to flow simultaneously when the polarity of the current iL1 is positive and performed the shift control. On the other hand, FIG. 16 is a timing chart illustrating how the power converter 100 operates when the controller 50 does not perform the shift control. Note that the timing charts shown in FIGS. 15 and 16 each show the waveforms in only a part of one cycle of the carrier signa 1.

Each of FIGS. 15 and 16 is a timing chart showing the waveforms of control signals SU1, SU2, SV1, SV2, SW1, SW2, SU6, SV6, SW6, load currents iU, iV, a current iL1, and voltages V2u, V2v, V2w across the second switching elements 2U, 2V, 2W. The controller 50 sets the length of the high-level period of each of the control signals SU6, SV6, SW6 at a resonant half cycle (Tre/2) and sets the dead time period Td at a length as long as the resonant half cycle. Note that as shown in FIGS. 15 and 16, if the load current iU=0, the load current iV=0, and the load current iW=0, then the controller 50 sets the additional times Tau, Tav, Taw already described for the first embodiment at zero.

In the example shown in FIG. 15, the controller 50 regards the control signals SU6, SW6 to be applied to the two switches 8U, 8W, respectively, as the targets of shifting. However, this is only an example and should not be construed as limiting. In the example shown in FIG. 15, the controller 50 shifts the high-level period of the control signal SU6 by a first shifted time T1 in such a direction as to advance the beginning time of the high-level period of the control signal SU6 for the switch 8U to prevent the resonant currents from overlapping between one of the two switches 8 as the targets of shifting and another switch 8 that is not the target of shifting (e.g., to prevent the U-phase resonant current and the V-phase resonant current from flowing simultaneously in this example). In addition, the controller 50 shifts the high-level period of the control signal SW6 by a second shifted time T2 in such a direction as to postpone the beginning time of the high-level period of the control signal SW6 for the switch 8W to prevent the resonant currents from overlapping between the other of the two switches 8 as the targets of shifting and the other two switches 8 (e.g., to prevent the W-phase resonant current and any of the U-phase resonant current or the V-phase resonant current from flowing simultaneously in this example). In FIG. 15, the state of the control signals SU6, SW6 before their high-level period is shifted (i.e., the state shown in FIG. 16) is indicated by the two-dot chain, and their state after their high-level period has been shifted is indicated by the solid line.

FIG. 15 illustrates an example in which the controller 50 defines the first shifted time T1 to be T1=Tres/2+Δ. Also, a situation where T2=Tres/2+Δ is satisfied is shown in FIGS. 15, where Δ is a time margin to be left to avoid an overlap between two-phase resonant currents with more reliability. Note that in the example shown in FIG. 15, the high-level period of the control signal SU6 for the switch 8U is shifted by the first shifted time T1 in such a direction as to advance the beginning time of the high-level period of the control signal SU6 and the high-level period of the control signal SW6 for the switch 8W is shifted by the second shifted time T2 in such a direction as to postpone the beginning time of the high-level period of the control signal SW6. However, this is only an example and should not be construed as limiting. Alternatively, the high-level period of the control signal SW6 for the switch 8W may be shifted by the first shifted time T1 in such a direction as to advance the beginning time of the high-level period of the control signal SW6 and the high-level period of the control signal SU6 for the switch 8U may be shifted by the second shifted time T2 in such a direction as to postpone the beginning time of the high-level period of the control signal SU6. Furthermore, the combination of two switches 8 as the targets of shifting does not have to be the combination of the switches 8U and 8W but may also be a combination of the switches 8U, 8V or a combination of the switches 8V, 8W.

In the power converter 100 according to the third embodiment, each of the first shifted time T1 and the second shifted time T2 is a predetermined period. Note that the upper limit value (maximum value) of the first shifted time T1 in a situation where the control signal for the switch 8 has its high-level period shifted to be advanced is a shifted time in a situation where the time lag between the beginning time of one cycle of a carrier signal and the beginning time of the high-level period of the shifted control signal (i.e., the control signal for the switch 8 which has been shifted) becomes equal to a minimum value (of zero, for example) without changing the length of the high-level period. On the other hand, the upper limit value (maximum value) of the second shifted time T2 in a situation where the control signal for the switch 8 has its high-level period shifted to be postponed is a shifted time in a situation where the time lag between the end time of one cycle of a carrier signal and the end time of the high-level period of the shifted control signal (i.e., the control signal for the switch 8 which has been shifted) becomes equal to a minimum value (of zero, for example) without changing the length of the high-level period.

In the power converter 100, if the controller 50 does not perform the shift control, the voltages V2u, V2v, V2w across the second switching elements 2U, 2V 2W do not rise to Vd at a point in time when the control signals SU1, SV1, SW1 make a transition from a low-level period to a high-level period (i.e., the end time of the dead time period Td corresponding to each of U-, V- and W-phases) as shown in FIG. 16. That is to say, in the power converter 100, if the controller 50 does not perform the shift control, the resonant capacitors 9U, 9V, 9W have not been charged with electricity yet at the end time of the dead time period Td corresponding to each of U-, V- and W-phases. Therefore, in the power converter 100, if the controller 50 does not perform the shift control, then none of the voltages across the first switching elements 1U, 1V, 1W decreases to zero at the end time of the dead time period Td corresponding to each of U-, V-, and W-phases. Consequently, in the power converter 100, the first switching elements 1U, 1V, 1W are hard-switched.

On the other hand, in the power converter 100, if the controller 50 has performed the shift control, the voltages V2u, V2v, V2w across the second switching elements 2U, 2V, 2W rise to Vd at a point in time when the control signals SU1, SV1, SW1 make a transition from a low-level period to a high-level period (i.e., the end time of the dead time period Td corresponding to each of U-, V-, and W-phases) as shown in FIG. 15. That is to say, in the power converter 100, if the controller 50 has performed the shift control, then the resonant capacitors 9U, 9V, 9W have already been charged with electricity at the end time of the dead time period Td corresponding to each of U-, V-, and W-phases. Therefore, in the power converter 100, if the controller 50 has performed the shift control, the first switching elements 1U, 1V, 1W are switched by zero-voltage soft switching.

Note that if the controller 50 determines that the three-phase resonant currents be going to overlap with each other, the relationship in polarity and magnitude between the three-phase load currents does not have to be defined to satisfy iU=0, iV=0, and iW=0 but may also be defined to satisfy either iU>0>iV or iW>iV>0>iU, whichever is appropriate.

Also, as long as the control signals for the three switches 8 overlap with each other at least partially, the temporal relationship between the control signals for the first switching elements 1 or the temporal relationship between the control signals for the second switching elements 2 is not limited to any particular one. For example, the beginning time of the high-level period of the control signal SV6 may be earlier than the beginning time of the high-level period of the control signal SU6 and the beginning time of the control signal SU6 may be earlier than the beginning time of the control signal SW6. Furthermore, in the operation of soft-switching the first switching elements (i.e., the operation of charging the resonant capacitors 9 with electricity), if three-phase resonant currents flow simultaneously and a load current is positive, the additional time Tau, Tav, Taw is preferably added to the high-level period of the switch 8 corresponding to a phase in which the positive load current flows as in the basic example described above.

### (1.2.2) Operation of Soft-Switching Second Switching Element

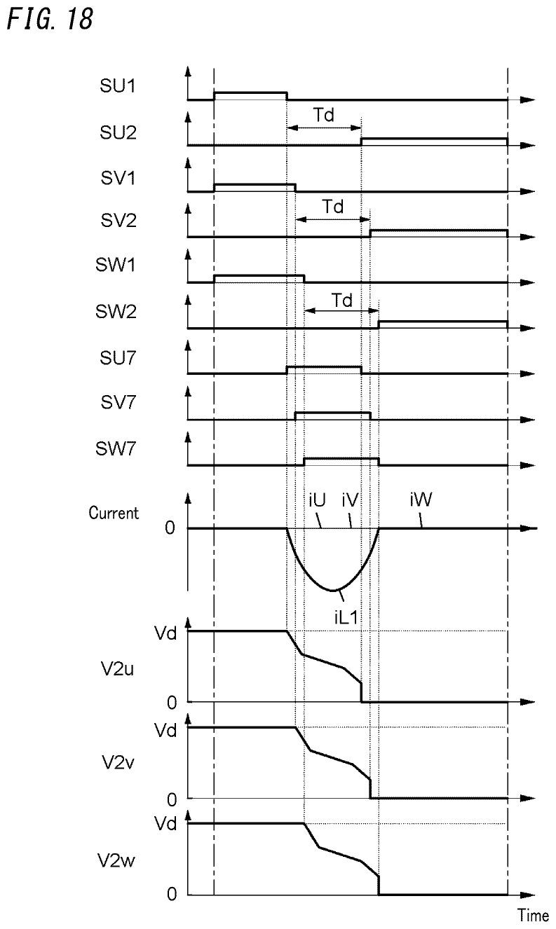

FIG. 17 is a timing chart illustrating how the power converter 100 operates when the controller 50 has determined that three-phase resonant currents, namely, the U-, V-, and W-phase resonant currents, be going to flow simultaneously when the polarity of the current iL1 is negative and performed the shift control. On the other hand, FIG. 18 is a timing chart illustrating how the power converter 100 operates when the controller 50 does not perform the shift control. Note that the timing charts shown in FIGS. 17 and 18 each show the waveforms in only a part of one cycle of the carrier signal.

Each of FIGS. 17 and 18 is a timing chart showing the waveforms of control signals SU1, SU2, SV1, SV2, SW1, SW2, SU7, SV7, SW7, load currents iU, iV, a current iL1, and voltages V2u, V2v, V2w across the second switching elements 2U, 2V, 2W. The controller 50 sets the length of the high-level period of each of the control signals SU7, SV7, SW7 at a resonant half cycle (Tre/2) and sets the dead time period Td at a length as long as the resonant half cycle. Note that as shown in FIGS. 17 and 18, if the load current iU=0, the load current iV=0, and the load current iW=0, then the controller 50 sets the additional times Tau, Tav, Taw already described for the first embodiment at zero.

In the example shown in FIG. 17, the controller 50 regards the control signals SU7, SW7 to be applied to the two switches 8U, 8W, respectively, as the targets of shifting. However, this is only an example and should not be construed as limiting. In the example shown in FIG. 17, the controller 50 shifts the high-level period of the control signal SU7 for the switch 8U by a first shifted time T1 in such a direction as to advance the beginning time of the high-level period of the control signal SU7 to prevent the resonant currents from overlapping between one of the two switches 8 as the targets of shifting and another switch 8 that is not the target of shifting (e.g., to prevent the U-phase resonant current and the V-phase resonant current from flowing simultaneously in this example). In addition, the controller 50 shifts the high-level period of the control signal SW7 for the switch 8W by a second shifted time T2 in such a direction as to postpone the beginning time of the high-level period of the control signal SW7 to prevent the resonant currents from overlapping between the other of the two switches 8 as the targets of shifting and the other two switches 8 (e.g., to prevent the W-phase resonant current and any of the U-phase resonant current or the V-phase resonant current from flowing simultaneously in this example). In FIG. 17, the state of the control signals SU7, SW7 before their high-level period is shifted (i.e., the state shown in FIG. 18) is indicated by the two-dot chain, and their state after their high-level period has been shifted is indicated by the solid line.

FIG. 17 illustrates an example in which the controller 50 defines the first shifted time T1 to be T1=Tres/2+Δ. Also, a situation where T2=Tres/2+Δ is satisfied is shown in FIG. 17, where Δ is a time margin to be left to avoid an overlap between two-phase resonant currents with more reliability. Note that in the example shown in FIG. 17, the high-level period of the control signal SU7 for the switch 8U is shifted by the first shifted time T1 in such a direction as to advance the beginning time of the high-level period of the control signal SU7 and the high-level period of the control signal SW7 for the switch 8W is shifted by the second shifted time T2 in such a direction as to postpone the beginning time of the high-level period of the control signal SW7. However, this is only an example and should not be construed as limiting. Alternatively, the high-level period of the control signal SW7 for the switch 8W may be shifted by the first shifted time T1 in such a direction as to advance the beginning time of the high-level period of the control signal SW7 and the high-level period of the control signal SU7 for the switch 8U may be shifted by the second shifted time T2 in such a direction as to postpone the beginning time of the high-level period of the control signal SU7. Furthermore, the combination of two switches 8 as the targets of shifting does not have to be the combination of the switches 8U and 8W but may also be a combination of the switches 8U, 8V or a combination of the switches 8V, 8W.

In the power converter 100, if the controller 50 does not perform the shift control, the voltages V2u, V2v, V2w across the second switching elements 2U, 2V 2W do not decrease to zero at a point in time when the control signals SU2, SV2, SW2 make a transition from a low-level period to a high-level period (i.e., the end time of the dead time period Td corresponding to each of U-, V- and W-phases) as shown in FIG. 18. That is to say, in the power converter 100, if the controller 50 does not perform the shift control, electricity has not been discharged from the resonant capacitors 9U, 9V, 9W yet at the end time of the dead time period Td corresponding to each of U-, V- and W-phases. Therefore, in the power converter 100, if the controller 50 does not perform the shift control, then none of the voltages across the second switching elements 2U, 2V, 2W decreases to zero at the end time of the dead time period Td corresponding to each of U-, V-, and W-phases. Consequently, in the power converter 100, the second switching elements 2U, 2V, 2W are hard-switched.

On the other hand, in the power converter 100, if the controller 50 has performed the shift control, the voltages V2u, V2v, V2w across the second switching elements 2U, 2V, 2W decrease to zero at a point in time when the control signals SU2, SV2, SW2 make a transition from a low-level period to a high-level period (i.e., the end time of the dead time period Td corresponding to each of U-, V-, and W-phases) as shown in FIG. 17. That is to say, in the power converter 100, if the controller 50 has performed the shift control, then electricity has been discharged from the resonant capacitors 9U, 9V, 9W at the end time of the dead time period Td corresponding to each of U-, V-, and W-phases. Therefore, in the power converter 100, if the controller 50 has performed the shift control, the second switching elements 2U, 2V, 2W are switched by zero-voltage soft switching.

### (2) Recapitulation

In the power converter 100 according to the third embodiment, when determining that resonant currents respectively passing through three switches 8 be going to flow simultaneously through the resonant inductor L1, the controller 50 performs the control of shifting the respective high-level periods of control signals for two switches 8 out of the three switches 8 to prevent the resonant currents respectively flowing through the three switches 8 from flowing simultaneously through the resonant inductor L1. This allows the power converter 100 to make soft switching with more reliability.

### Fourth Embodiment

A power converter 100 according to a fourth embodiment has the same circuit configuration as the power converter 100 according to the first embodiment (refer to FIG. 1) described above, and therefore, illustration and description thereof will be omitted herein.

In the power converter 100 according to the fourth embodiment, the shift control operation performed by the controller 50 that has determined that three-phase resonant currents be going to overlap with each other is different from the shift control operation performed by the controller 50 according to the third embodiment.

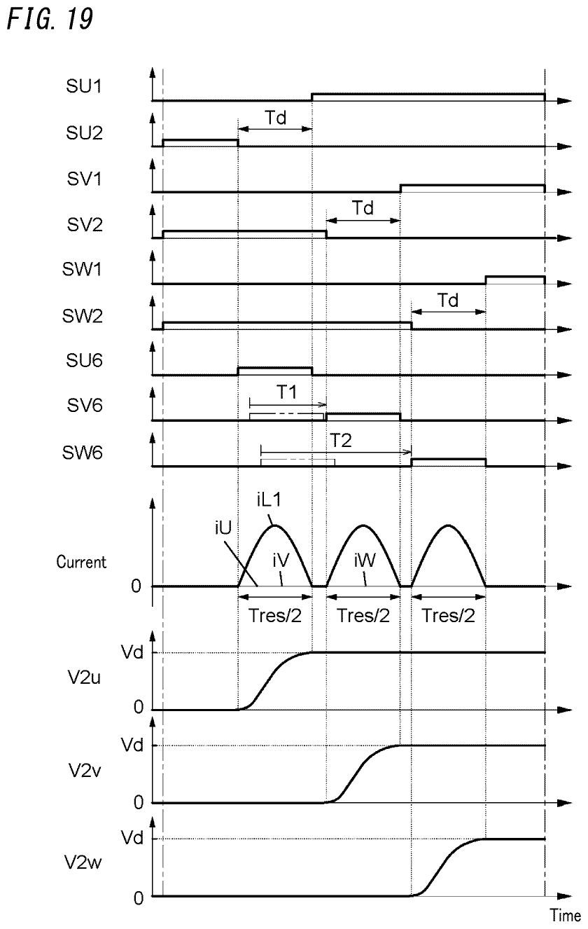

It will be described with reference to FIG. 19 how the controller 50 operates when determining that resonant currents respectively passing through three switches 8 belonging to the plurality of switches 8 be going to flow simultaneously through the resonant inductor L1. When determining that the resonant currents respectively passing through the three switches 8 belonging to the plurality of switches 8 be going to flow simultaneously through the resonant inductor L1, the controller 50 performs the shift control operation.

As in the third embodiment described above, when performing the shift control, the controller 50 shifts the respective high-level periods of the control signals for the two switches 8 to prevent the length of the respective high-level periods of the control signals to be applied to the first switching element 1 and second switching element 2 of one switching circuit 10 connected to the two switches 8 which belong to the plurality of switching circuits 10 from changing.

Furthermore, in the fourth embodiment, when performing the shift control, the controller 50 selects any two switches 8 as the target of shifting from the three switches 8 and shifts the respective high-level periods of the two switches 8 as the target of shifting in the same direction to prevent the resonant currents respectively passing through the three switches 8 from flowing simultaneously through the resonant inductor L1.

FIG. 19 is a timing chart illustrating how the power converter 100 operates when the controller 50 has determined that three-phase resonant currents, namely, the U-, V-, and W-phase resonant currents, be going to flow simultaneously when the polarity of the current iL1 is positive and performed the shift control. On the other hand, FIG. 16, which has already been referred to in the description of the third embodiment, is a timing chart illustrating how the power converter 100 operates when the controller 50 does not perform the shift control. Note that the timing chart shown in FIG. 19 shows the waveforms in only a part of one cycle of the carrier signal.

FIG. 19, as well as FIG. 16, is a timing chart showing the waveforms of control signals SU1, SU2, SV1, SV2, SW1, SW2, SU6, SV6, SW6, load currents iU, iV, a current iL1, and voltages V2u, V2v, V2w across the second switching elements 2U, 2V, 2W. The controller 50 sets the length of the high-level period of each of the control signals SU6, SV6, SW6 at a resonant half cycle (Tre/2) and sets the dead time period Td at a length as long as the resonant half cycle. Note that as shown in FIG. 19, if the load current iU=0, the load current iV=0, and the load current iW=0, then the controller 50 sets the additional times Tau, Tav, Taw already described for the first embodiment at zero.

In the example shown in FIG. 19, the controller 50 regards the control signals SV6, SW6 to be applied to the two switches 8V, 8W, respectively, as the targets of shifting. However, this is only an example and should not be construed as limiting. In the example shown in FIG. 19, the controller 50 shifts the high-level period of the control signal SV6 for the switch 8V by a first shifted time T1 in such a direction as to postpone the beginning time of the high-level period of the control signal SV6 for the switch 8V to prevent the resonant currents from overlapping between one of the two switches 8 as the targets of shifting and another switch 8 that is not the target of shifting (e.g., to prevent the U-phase resonant current and the V-phase resonant current from flowing simultaneously in this example). In addition, the controller 50 also shifts the high-level period of the control signal SW6 for the switch 8W by a second shifted time T2 in such a direction as to postpone the beginning time of the high-level period of the control signal SW6 for the switch 8W to prevent the resonant currents from overlapping between the other of the two switches 8 as the targets of shifting and the other two switches 8 (e.g., to prevent the W-phase resonant current and any of the U-phase resonant current or the V-phase resonant current from flowing simultaneously in this example). In FIG. 19, the state of the control signals SV6, SW6 before their high-level period is shifted (i.e., the state shown in FIG. 16) is indicated by the two-dot chain, and their state after their high-level period has been shifted is indicated by the solid line.

FIG. 19 illustrates an example in which the controller 50 defines the first shifted time T1 to be T1=Tres/2+Δ. Also, a situation where T2=2×(Tres/2)+Δ is satisfied is shown in FIG. 19, where Δ is a time margin to be left to avoid an overlap between two-phase resonant currents with more reliability.

In the power converter 100 according to the fourth embodiment, if the controller 50 has performed the shift control, the voltages V2u, V2v, V2w across the second switching elements 2U, 2V, 2W rise to Vd at a point in time when the control signals SU1, SV1, SW1 make a transition from a low-level period to a high-level period (i.e., the end time of the dead time period Td corresponding to each of U-, V-, and W-phases) as shown in FIG. 19. That is to say, in the power converter 100, if the controller 50 has performed the shift control, then the resonant capacitors 9U, 9V, 9W have already been charged with electricity at the end time of the dead time period Td corresponding to each of U-, V-, and W-phases. Therefore, in the power converter 100, if the controller 50 has performed the shift control, the first switching elements 1U, 1V, 1W are switched by zero-voltage soft switching.

In the power converter 100 according to the fourth embodiment, when determining that resonant currents respectively passing through three switches 8 be going to flow simultaneously through the resonant inductor L1, the controller 50 performs the control of shifting the respective high-level periods of control signals for two switches 8 out of the three switches 8 to prevent the resonant currents respectively flowing through the three switches 8 from flowing simultaneously through the resonant inductor L1. This allows the power converter 100 to make soft switching with more reliability.

Note that in the example shown in FIG. 19, the high-level period of the control signal SV6 for the switch 8V is shifted by the first shifted time T1 in such a direction as to postpone the beginning time of the high-level period of the control signal SU6 and the high-level period of the control signal SW6 for the switch 8W is shifted by the second shifted time T2 in such a direction as to postpone the beginning time of the high-level period of the control signal SW6. However, this is only an example and should not be construed as limiting. Alternatively, the high-level period of the control signal SW6 for the switch 8W may be shifted by the first shifted time T1 in such a direction as to postpone the beginning time of the high-level period of the control signal SW6 for the switch 8W and the high-level period of the control signal SV6 for the switch 8V may be shifted by the second shifted time T2 in such a direction as to postpone the beginning time of the high-level period of the control signal SV6. Furthermore, the combination of two switches 8 as the targets of shifting does not have to be the combination of the switches 8V and 8W but may also be a combination of the switches 8U, 8V or a combination of the switches 8U, 8W. Furthermore, the shifting direction does not have to be such a direction as to postpone the high-level periods of the control signals for the two switches 8 but may also be such a direction as to advance the high-level periods of the control signals for the two switches 8. Furthermore, in the example shown in FIG. 19, the second shifted time T2 is longer than the first shifted time T1. However, this is only an example and should not be construed as limiting. Alternatively, the first shifted time T1 may be longer than the second shifted time T2.

Although FIG. 19 illustrates the operation of soft-switching the first switching elements 1U, 1V, 1W, the shift control operation may be performed in the same way in the case of the operation of soft-switching the second switching elements 2U, 2V, 2W.

A power converter 100 according to a variation of the fourth embodiment may reduce the bias of a variation in the ripple of a line voltage by, for example, making the controller 50 change as appropriate the combination of two switches 8 as the targets of shift control.

### Fifth Embodiment

A power converter 100 according to a fifth embodiment has the same circuit configuration as the power converter 100 according to the first embodiment (refer to FIG. 1) described above, and therefore, illustration and description thereof will be omitted herein.

In the power converter 100 according to the fifth embodiment, the shift control operation performed by the controller 50 that has determined that three-phase resonant currents be going to overlap with each other is different from the shift control operation performed by the controller 50 according to the third embodiment. In the fifth embodiment, the controller 50 performs the shift control to prevent resonant currents from overlapping with each other in any combination of one switch 8 out of the three switches 8 and the other two switches 8.

In the fifth embodiment, when determining that resonant currents passing respectively through the three switches 8 be going to flow simultaneously through the resonant inductor L1, the controller 50 performs, when a first condition is satisfied, first shift control as the shift control in a situation where a charging operation of charging the plurality of resonant capacitors 9 with electricity is going to be performed and performs, when a second condition is satisfied, second shift control as the shift control in a situation where a discharging operation of discharging electricity from the plurality of resonant capacitors 9 is going to be performed.

The first condition is a condition that a time lag between the beginning time of a high-level period of a control signal which is longest among respective high-level periods of control signals SU1, SV1, SW1 to be applied to the three first switching elements 1, respectively, and the beginning time of a high-level period of a control signal which is shortest among the respective high-level periods of the control signals SU1, SV1, SW1 to be applied to the three first switching elements 1 be longer than a resonant half cycle Tres. The resonant half cycle Tres is a value that is one half of a resonant cycle which is determined by a reciprocal of a resonant frequency of a resonant circuit including the resonant inductor L1 and one of the plurality of resonant capacitors 9. The first shift control includes control of shifting a high-level period of a control signal for a switch 8 corresponding to a first switching element 1, to which a control signal, having a second longest high-level period among the control signals SU1, SV1, SW1 to be applied to the three first switching elements 1, respectively, is applied. The second condition is a condition that a time lag between a beginning time of a high-level period of a control signal which is longest among respective high-level periods of control signals SU2, SV2, SW2 to be applied to the three second switching elements 2, respectively, and a beginning time of a high-level period of a control signal which is shortest among the respective high-level periods of the control signals SU2, SV2, SW2 to be applied to the three second switching elements 2, respectively, be longer than the resonant half cycle Tres. The second shift control includes control of shifting a high-level period of a control signal for a switch 8 corresponding to a second switching element 2, to which a control signal, having a second longest high-level period among the control signals SU2, SV2, SW2 to be applied to the three second switching elements 2, respectively, is applied. When performing the shift control (which is either the first shift control or the second shift control), the controller 50 shifts the high-level period of a control signal for the switch 8 to prevent the high-level periods of a control signal to be applied to the switch 8 from changing their length.

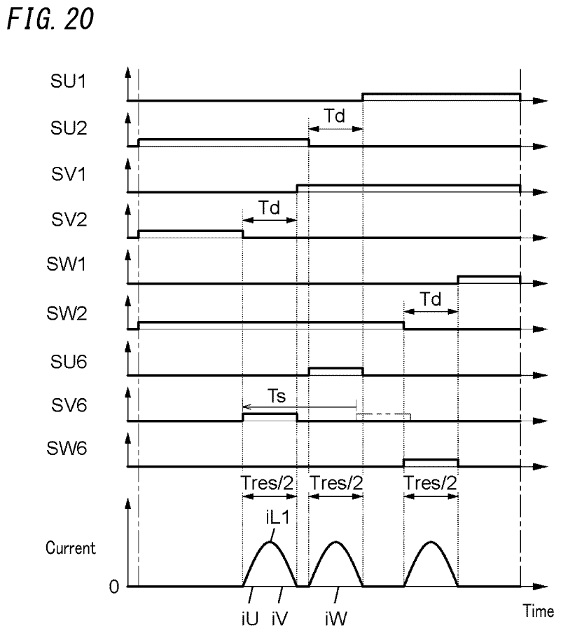

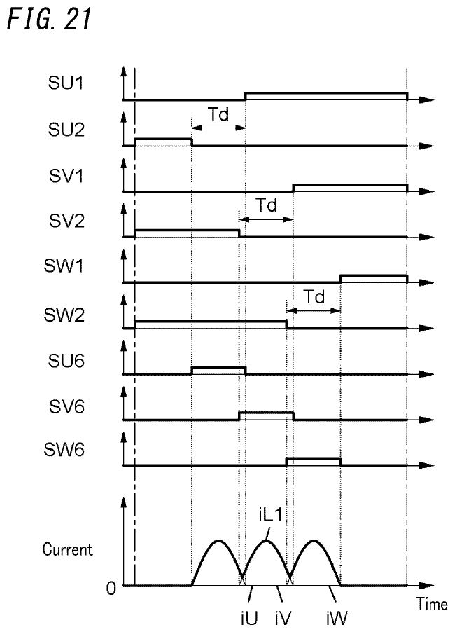

FIG. 20 is a timing chart illustrating how the power converter 100 operates if the controller 50 has determined that resonant currents respectively passing through the three switches 8 be going to flow simultaneously and has performed the first shift control in the case of the charging operation of charging the plurality of resonant capacitors 9 with electricity. On the other hand, FIG. 21 is a timing chart illustrating how the power converter 100 operates when the controller 50 does not perform the first shift control. Note that the timing charts shown in FIGS. 20 and 21 each show the waveforms in only a part of one cycle of the carrier signal.

Each of FIGS. 20 and 21 is a timing chart showing the waveforms of control signals SU1, SU2, SV1, SV2, SW1, SW2, SU6, SV6, SW6, load currents iU, iV, iW, and a current iL1. The controller 50 sets the length of the high-level period of each of the control signals SU6, SV6, SW6 at a resonant half cycle (Tre/2) and sets the dead time period Td at a length as long as the resonant half cycle. Note that as shown in FIGS. 20 and 21, if the load current iU=0, the load current iV=0, and the load current iW=0, then the controller 50 sets the additional times Tau, Tav, Taw already described for the first embodiment at zero.

In the example shown in FIG. 20, [length of high-level period of control signal SU1]>[length of high-level period of control signal SV1]>[length of high-level period of control signal SW1] is satisfied, and therefore, the controller 50 shifts, by a shifted time Ts, the high-level period of the control signal SV6 for the switch 8V corresponding to the first switching element 1V, to which the control signal SV1 is applied, in such a direction as to advance the high-level period of the control signal SV6. In the fifth embodiment, the shifted time Ts is the predetermined period. In FIG. 20, the state of the control signal SV6 before its high-level period is shifted (i.e., the state shown in FIG. 21) is indicated by the two-dot chain, and the state after its high-level period has been shifted is indicated by the solid line. In the example shown in FIG. 20, the controller 50 shifts, by the shifted time Ts, the high-level period of the control signal SV6 in such a direction as to advance the beginning time of the high-level period of the control signal SV6 for the switch 8V to prevent the resonant current flowing through the switch 8V and the resonant current flowing through the switch 8U from flowing simultaneously through the resonant inductor L1 and prevent the resonant current flowing through the switch 8V and the resonant current flowing through the switch 8W from flowing simultaneously through the resonant inductor L1. The length of the predetermined period (i.e., the shifted time Ts) may be, for example, 2 x Tres/ 2. However, the length of the predetermined period is not limited to this length but may also be any other length as long as the overlap of the resonant currents may be avoided. Furthermore, the direction in which the high-level period of the control signal SV6 is shifted does not have to be such a direction as to advance the high-level period but may also be such a direction as postpone the high-level period.

In the power converter 100 according to the fifth embodiment, if the controller 50 has performed the shift control, the voltages V2u, V2v, V2w across the second switching elements 2U, 2V, 2W increase to Vd at a point in time when the control signals SU1, SV1, SW1 make a transition from a low-level period to a high-level period (i.e., the end time of the dead time period Td corresponding to each of U-, V-, and W-phases). That is to say, in the power converter 100, if the controller 50 has performed the shift control, then the resonant capacitors 9U, 9V, 9W have already been charged with electricity at the end time of the dead time period Td corresponding to each of U-, V-, and W-phases. Therefore, in the power converter 100, if the controller 50 has performed the shift control, the first switching elements 1U, 1V, 1W are switched by zero-voltage soft switching.

Furthermore, in the power converter 100 according to the fifth embodiment, the second switching elements 2U, 2V, 2W may be subjected to zero-voltage soft switching by making the controller 50 perform the second shift control when the second condition is satisfied.

As can be seen from the foregoing description, the power converter 100 according to the fifth embodiment may perform soft switching with more reliability.

### Sixth Embodiment

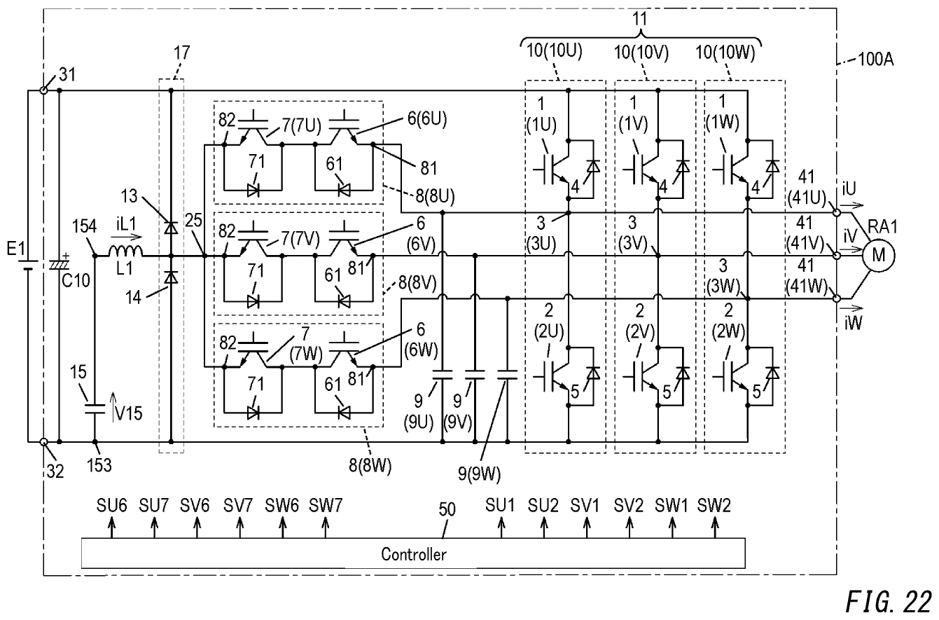

A power converter 100A according to a sixth embodiment will be described with reference to FIG. 22. In the following description, any constituent element of the power converter 100A according to the sixth embodiment, having the same function as a counterpart of the power converter 100 according to the first embodiment described above, will be designated by the same reference numeral as that counterpart's, and description thereof will be omitted herein.

In the power converter 100A according to the sixth embodiment, in each of the plurality of switches 8, the first IGBT 6 and second IGBT 7 thereof are connected in anti-series. In the power converter 100A according to the sixth embodiment, in each of the plurality of switches 8, the collector terminal of the first IGBT 6 and the collector terminal of the second IGBT 7 are connected to each other, the emitter terminal of the first IGBT 6 is connected to the connection node 3 of a corresponding one of the plurality of switching circuits 10, and the emitter terminal of the second IGBT 7 is connected to the common connection node 25. In addition, each of the plurality of switches 8 further includes a diode 61 connected to the first IGBT 6 in antiparallel and a diode 71 connected to the second IGBT 7 in antiparallel.

In the power converter 100A according to the sixth embodiment, each of the first IGBT 6 and the second IGBT 7 may be replaced with either a MOSFET or a bipolar transistor. In that case, the diode 61 and diode 71 shown in FIG. 22 may each be replaced with, for example, either a parasitic diode of the replacement element or an element built in one chip of the replacement element. Also, in the power converter 100A according to the sixth embodiment, the diode 61 and the diode 71 do not have to be provided as external elements for the first IGBT 6 and the second IGBT 7, respectively, but may also be elements built in one chip.

The controller 50 may operate in the same way as, for example, the controller 50 according to the first embodiment. However, this is only an example and should not be construed as limiting. Alternatively, the controller 50 may operate in the same way as the controller 50 according to any of the second to fifth embodiments described above and may also perform the shift control that is performed by the controller 50 according to the first to fifth embodiments.

### Seventh Embodiment

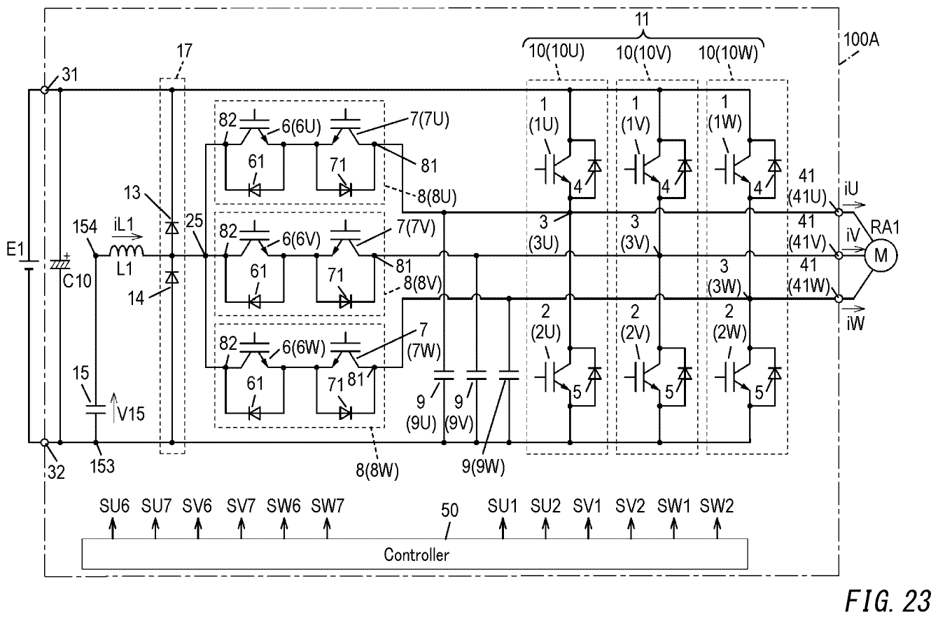

A power converter 100A according to a seventh embodiment will be described with reference to FIG. 23. In the following description, any constituent element of the power converter 100A according to the seventh embodiment, having the same function as a counterpart of the power converter 100 according to the first embodiment described above, will be designated by the same reference numeral as that counterpart's, and description thereof will be omitted herein.

In the power converter 100A according to the seventh embodiment, in each of the plurality of switches 8, the first IGBT 6 and second IGBT 7 thereof are connected in anti-series. In the power converter 100A according to the seventh embodiment, in each of the plurality of switches 8, the emitter terminal of the first IGBT 6 and the emitter terminal of the second IGBT 7 are connected to each other, the collector terminal of the second IGBT 7 is connected to the connection node 3 of a corresponding one of the plurality of switching circuits 10, and the collector terminal of the first IGBT 6 is connected to the common connection node 25. In addition, each of the plurality of switches 8 further includes a diode 61 connected to the first IGBT 6 in antiparallel and a diode 71 connected to the second IGBT 7 in antiparallel.

In the power converter 100A according to the seventh embodiment, each of the first IGBT 6 and the second IGBT 7 may be replaced with either a MOSFET or a bipolar transistor. In that case, the diode 61 and diode 71 shown in FIG. 23 may each be replaced with, for example, either a parasitic diode of the replacement element or an element built in one chip of the replacement element. Also, in the power converter 100A according to the seventh embodiment, the diode 61 and the diode 71 do not have to be provided as external elements for the first IGBT 6 and the second IGBT 7, respectively, but may also be elements built in one chip.

The controller 50 may operate in the same way as, for example, the controller 50 according to the first embodiment. However, this is only an example and should not be construed as limiting. Alternatively, the controller 50 may operate in the same way as the controller 50 according to any of the second to fifth embodiments described above and may also perform the shift control that is performed by the controller 50 according to the first to fifth embodiments.

### Eighth Embodiment

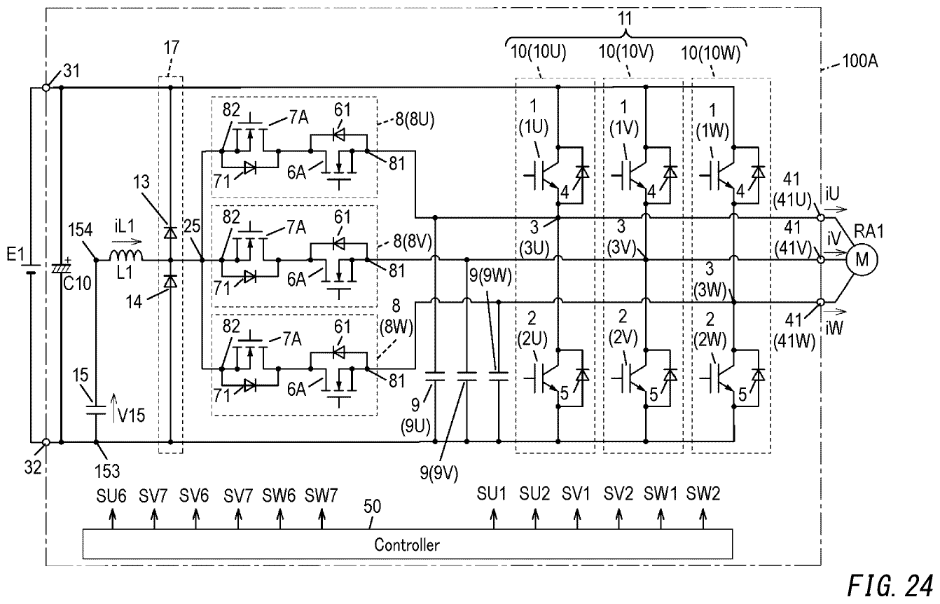

A power converter 100A according to an eighth embodiment will be described with reference to FIG. 24. In the following description, any constituent element of the power converter 100A according to the eighth embodiment, having the same function as a counterpart of the power converter 100 according to the first embodiment described above, will be designated by the same reference numeral as that counterpart's, and description thereof will be omitted herein.

In the power converter 100A according to the eighth embodiment, in each of the plurality of switches 8, a first MOSFET 6A and a second MOSFET 7A are connected in anti-series. In the power converter 100A according to the eighth embodiment, in each of the plurality of switches 8, the drain terminal of the first MOSFET 6A and the drain terminal of the second MOSFET 7A are connected to each other. In addition, each of the plurality of switches 8 further includes a diode 61 connected to the first MOSFET 6A in antiparallel and a diode 71 connected to the second MOSFET 7A in antiparallel. In each of the plurality of switches 8, the source terminal of the second MOSFET 7A is connected to the common connection node 25. In each of the plurality of switches 8, the source terminal of the first MOSFET 6A is connected to the connection node 3 of a switching circuit 10 corresponding to the switch 8 including the first MOSFET 6A. Control signals SU6, SU7 are respectively applied from the controller 50 to the first MOSFET 6A and second MOSFET 7A of the switch 8U. Control signals SV6, SV7 are respectively applied from the controller 50 to the first MOSFET 6A and second MOSFET 7A of the switch 8V. Control signals SW6, SW7 are respectively applied from the controller 50 to the first MOSFET 6A and second MOSFET 7A of the switch 8W.

The controller 50 may operate in the same way as, for example, the controller 50 according to the first embodiment. However, this is only an example and should not be construed as limiting. Alternatively, the controller 50 may operate in the same way as the controller 50 according to any of the second to fifth embodiments described above and may also perform the shift control that is performed by the controller 50 according to the first to fifth embodiments.

### Ninth Embodiment

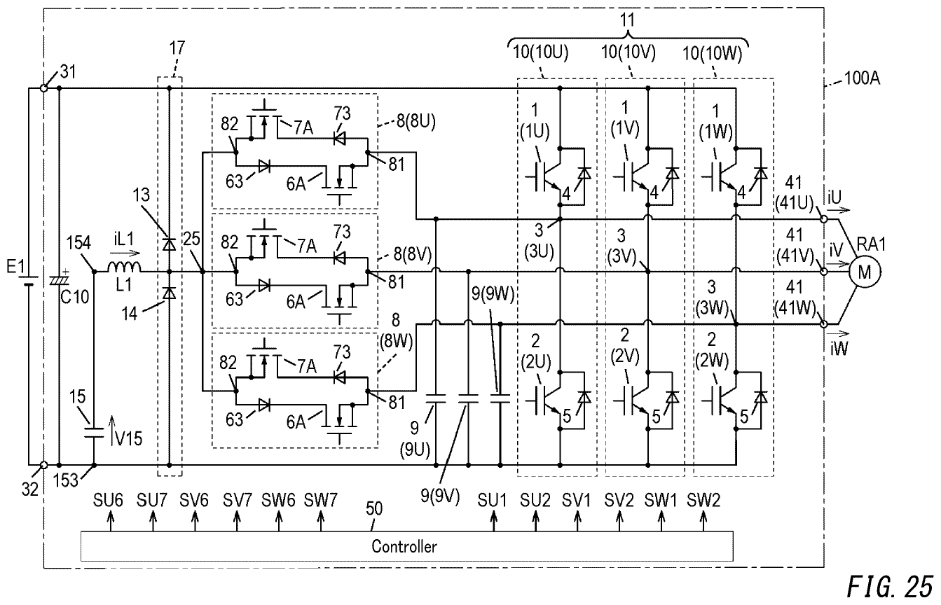

A power converter 100A according to a ninth embodiment will be described with reference to FIG. 25. In the following description, any constituent element of the power converter 100A according to the ninth embodiment, having the same function as a counterpart of the power converter 100 according to the first embodiment described above, will be designated by the same reference numeral as that counterpart's, and description thereof will be omitted herein.

In the power converter 100A according to the ninth embodiment, in each of the plurality of switches 8, a diode 63 is connected to a first MOSFET 6A in series and a diode 73 is connected to a second MOSFET 7A in series. In the power converter 100A according to the ninth embodiment, a series circuit of the first MOSFET 6A and the diode 63 and a series circuit of the second MOSFET 7A and the diode 73 are connected to each other in antiparallel.

The controller 50 may operate in the same way as, for example, the controller 50 according to the first embodiment. However, this is only an example and should not be construed as limiting. Alternatively, the controller 50 may operate in the same way as the controller 50 according to any of the second to fifth embodiments described above and may also perform the shift control that is performed by the controller 50 according to the first to fifth embodiments.

### Tenth Embodiment

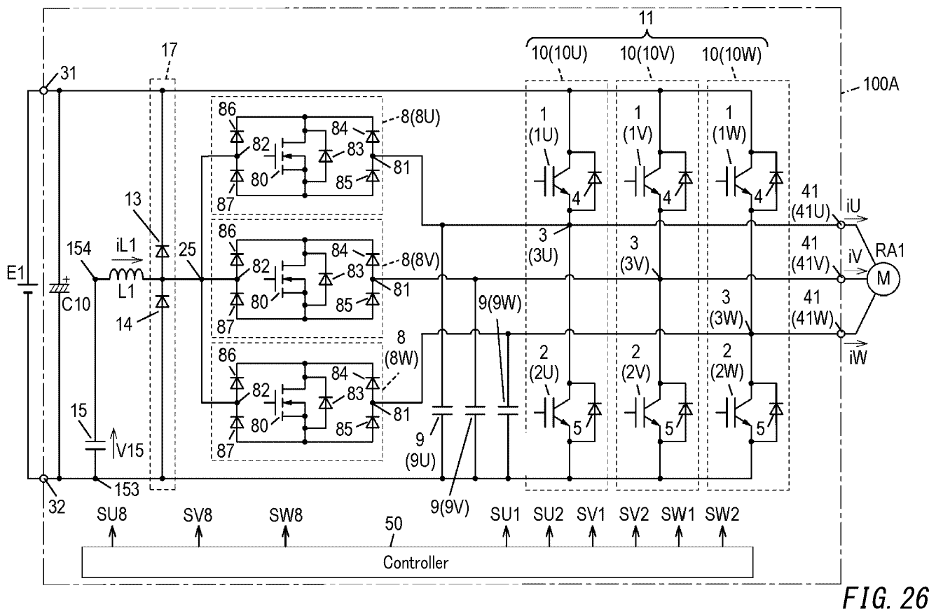

A power converter 100A according to a tenth embodiment will be described with reference to FIG. 26. In the following description, any constituent element of the power converter 100A according to the tenth embodiment, having the same function as a counterpart of the power converter 100 according to the first embodiment described above, will be designated by the same reference numeral as that counterpart's, and description thereof will be omitted herein.

In the power converter 100A according to the tenth embodiment, each of the plurality of switches 8 includes: a MOSFET 80; a diode 83 connected to the MOSFET 80 in antiparallel; a series circuit of two diodes 84, 85 connected to the MOSFET 80 in antiparallel; and a series circuit of two diodes 86, 87 connected to the MOSFET 80 in antiparallel. In each of the plurality of switches 8, a connection node between the diodes 84, 85 in the switch 8 (i.e., a first end 81 of the switch 8) is connected to the connection node 3 of a corresponding one of the plurality of switching circuits 10, and a connection node between the diodes 86, 87 (i.e., a second end 82 of the switch 8) is connected to the common connection node 25. In each of the switches 8, when the MOSFET 80 is ON, the switch 8 is ON. On the other hand, when the MOSFET 80 is OFF, the switch 8 is OFF.

The MOSFETs 80 of the plurality of switches 8 are controlled by the controller 50. The controller 50 outputs a control signal SU8 for controlling the ON/OFF states of the MOSFET 80 of the switch 8U, a control signal SV8 for controlling the ON/OFF states of the MOSFET 80 of the switch 8V, and a control signal SW8 for controlling the ON/OFF states of the MOSFET 80 of the switch 8W.

In each of the switches 8, when its MOSFET 80 is ON, a resonant current produced by a resonant circuit including the resonant inductor L1 and a corresponding one of the resonant capacitors 9 flows. In the power converter 100A, a charging current including the resonant current flows, when one of the plurality of switches 8 is ON, along the path passing through the regenerative capacitor 15, the resonant inductor L1, the diode 86, the MOSFET 80, the diode 85, and the resonant capacitor 9 in this order. Also, in the power converter 100A, a discharging current including the resonant current flows, when one of the plurality of switches 8 is ON, along the path passing through the resonant capacitor 9, the diode 84, the MOSFET 80, the diode 87, the resonant inductor L1, and regenerative capacitor 15 in this order.

In the power converter 100A according to the tenth embodiment, each of the plurality of MOSFETs 80 may be replaced with an IGBT. Also, in the power converter 100A according to the tenth embodiment, each of the plurality of switches 8 may include, for example, a bipolar transistor or a GaN-based gate injection transistor (GIT) instead of the MOSFET 80.

The controller 50 may operate in the same way as, for example, the controller 50 according to the first embodiment. However, this is only an example and should not be construed as limiting. Alternatively, the controller 50 may operate in the same way as the controller 50 according to any of the second to fifth embodiments described above and may also perform the shift control that is performed by the controller 50 according to the first to fifth embodiments.

### Eleventh Embodiment

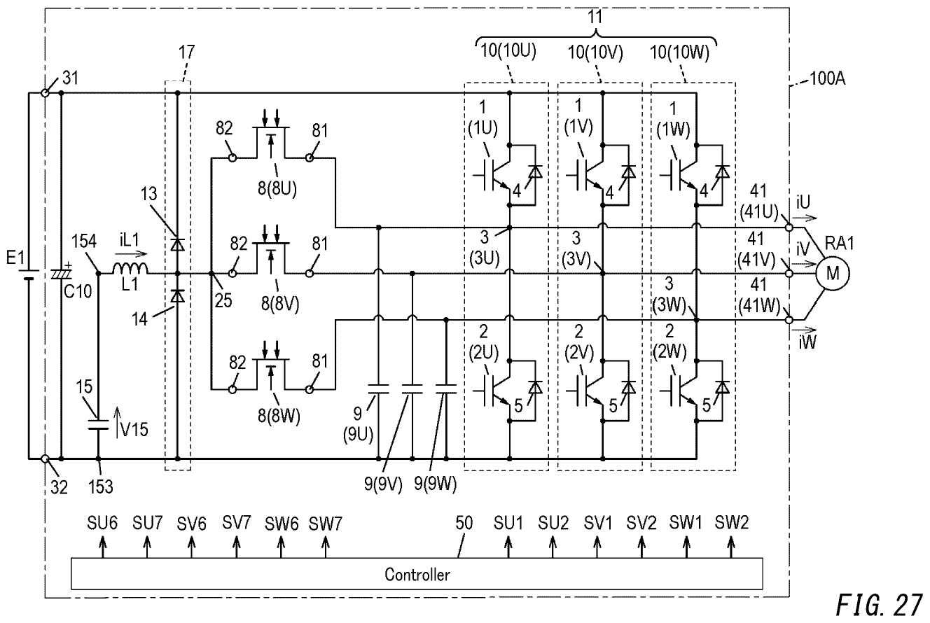

A power converter 100A according to an eleventh embodiment will be described with reference to FIG. 27. In the following description, any constituent element of the power converter 100A according to the eleventh embodiment, having the same function as a counterpart of the power converter 100 according to the first embodiment described above, will be designated by the same reference numeral as that counterpart's, and description thereof will be omitted herein.

In the power converter 100A according to the eleventh embodiment, each of the plurality of switches 8 is a dual-gate GaN-based GIT including a first source terminal, a first gate terminal, a second gate terminal, and a second source terminal. In the power converter 100A according to the eleventh embodiment, a control signal SU6 is applied to between the first gate terminal and first source terminal of a dual-gate GaN-based GIT serving as the switch 8U, and a control signal SU7 is applied to between the second gate terminal and the second source terminal thereof. In addition, a control signal SV6 is applied to between the first gate terminal and first source terminal of a dual-gate GaN-based GIT serving as the switch 8V, and a control signal SV7 is applied to between the second gate terminal and the second source terminal thereof. Furthermore, a control signal SW6 is applied to between the first gate terminal and first source terminal of a dual-gate GaN-based GIT serving as the switch 8W, and a control signal SW7 is applied to between the second gate terminal and the second source terminal thereof.

The controller 50 may operate in the same way as, for example, the controller 50 according to the first embodiment. However, this is only an example and should not be construed as limiting. Alternatively, the controller 50 may operate in the same way as the controller 50 according to any of the second to fifth embodiments described above and may also perform the shift control that is performed by the controller 50 according to the first to fifth embodiments.

### Twelfth Embodiment

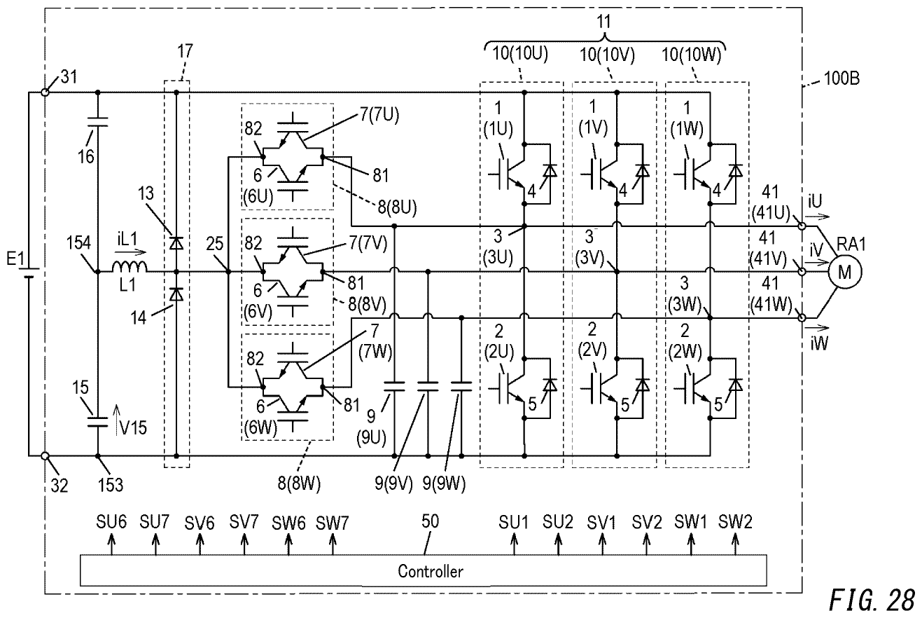

A power converter 100B according to a twelfth embodiment will be described with reference to FIG. 28. The power converter 100B according to the twelfth embodiment further includes a capacitor 16 connected between the second end of the resonant inductor L1 and the first DC terminal 31, which is a difference from the power converter 100 according to the first embodiment. In the following description, any constituent element of the power converter 100B according to the twelfth embodiment, having the same function as a counterpart of the power converter 100 according to the first embodiment described above, will be designated by the same reference numeral as that counterpart's, and description thereof will be omitted herein.

The power converter 100B does not include the capacitor C10 of the power converter 100 according to the first embodiment. The capacitor 16 is connected to the regenerative capacitor 15 in series. Thus, in this power converter 100B, a series circuit of the capacitor 16 and the regenerative capacitor 15 is connected between the first DC terminal 31 and the second DC terminal 32. The capacitance of the capacitor 16 is equal to the capacitance of the regenerative capacitor 15. As used herein, the expression “the capacitance of the capacitor 16 is equal to the capacitance of the regenerative capacitor 15” refers to not only a situation where the capacitance of the capacitor 16 is exactly equal to the capacitance of the regenerative capacitor 15 but also a situation where the capacitance of the capacitor 16 is equal to or greater than 95% and equal to or less than 105% of the capacitance of the regenerative capacitor 15 as well.

In the power converter 100B according to the twelfth embodiment, the potential V15 at the fourth end 154 of the regenerative capacitor 15 has a value calculated by dividing the voltage value Vd of the DC power supply E1 by two that is the number of the capacitors, namely, the capacitor 16 and the regenerative capacitor 15. Thus, the potential V15 at the fourth end 154 of the regenerative capacitor 15 is Vd/2. In the power converter 100B according to the twelfth embodiment, the controller 50 may store in advance the value of the potential V15 at the fourth end 154 of the regenerative capacitor 15.

The controller 50 of the power converter 100B according to the twelfth embodiment, as well as the controller 50 of the power converter 100 according to the first embodiment, performs the shift control. Thus, the power converter 100B according to the twelfth embodiment, as well as the power converter 100 according to the first embodiment, may make zero-voltage soft switching of each of the plurality of first switching elements 1 and the plurality of second switching elements 2.

The controller 50 may operate in the same way as, for example, the controller 50 according to the first embodiment. However, this is only an example and should not be construed as limiting. Alternatively, the controller 50 may operate in the same way as the controller 50 according to any of the second to fifth embodiments described above and may also perform the shift control that is performed by the controller 50 according to the first to fifth embodiments.

### Thirteenth Embodiment

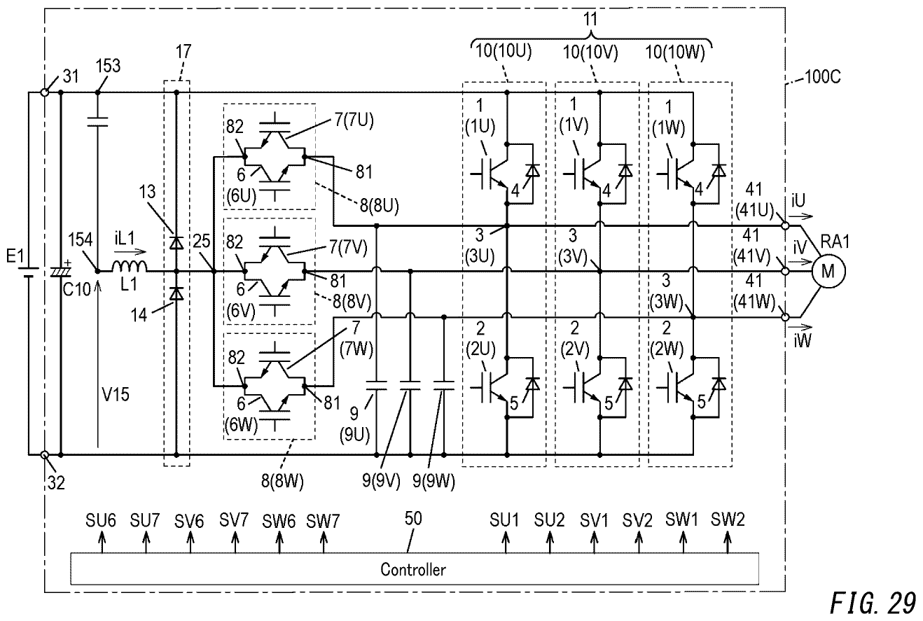

A power converter 100C according to a thirteenth embodiment will be described with reference to FIG. 29. In the power converter 100C according to the thirteenth embodiment, the regenerative capacitor 15 is connected between the second end of the resonant inductor LO and the first DC terminal 31, which is a difference from the power converter 100 according to the first embodiment. In the following description, any constituent element of the power converter 100C according to this thirteenth embodiment, having the same function as a counterpart of the power converter 100 according to the first embodiment described above, will be designated by the same reference numeral as that counterpart's, and description thereof will be omitted herein.

The controller 50 of the power converter 100C according to the thirteenth embodiment, as well as the controller 50 of the power converter 100 according to the first embodiment, performs the shift control. Thus, the power converter 100C according to the thirteenth embodiment, as well as the power converter 100 according to the first embodiment, may make soft switching with more reliability.

### Other Variations

Note that the first to thirteenth embodiments and their variations described above are only exemplary ones of various embodiments of the present disclosure and their variations and should not be construed as limiting. Rather, the first to thirteenth exemplary embodiments and their variations may be readily modified in various manners depending on a design choice or any other factor without departing from the scope of the present disclosure.

The operation performed by the controller 50 to “determine that a plurality of resonant currents be going to flow simultaneously” is not limited to the operation of “determining that a plurality of resonant currents be going to flow simultaneously” if the time lag described for the first embodiment is less than a threshold value and the operation of “determining that three-phase resonant currents be going to flow simultaneously” if the rotational velocity of the motor is less than a rotational velocity threshold value.

For example, the controller 50 may determine that three-phase resonant currents be going to flow simultaneously if the time lag between the beginning time of a high-level period of a control signal corresponding to the U-phase and the beginning time of a high-level period of a control signal corresponding to the V-phase, the time lag between the beginning time of the high-level period of the control signal corresponding to the V-phase and the beginning time of a high-level period of a control signal corresponding to the W-phase, and the time lag between the beginning time of the high-level period of the control signal corresponding to the W-phase and the beginning time of the high-level period of the control signal corresponding to the U-phase are all less than a threshold value.

Alternatively, the controller 50 may determine that two-phase resonant currents be going to flow simultaneously if any one of the current difference between the U-phase load current iU and the V-phase load current iV, the current difference between the V-phase load current iV and the W-phase load current iW, or the current difference between the W-phase load current iW and the U-phase load current iU is less than a current difference threshold value.

Still alternatively, the controller 50 may determine that three-phase resonant currents be going to flow simultaneously if the current difference between the U-phase load current iU and the V-phase load current iV, the current difference between the V-phase load current iV and the W-phase load current iW, and the current difference between the W-phase load current iW and the U-phase load current iU are all less than the current difference threshold value.

Yet alternatively, the controller 50 may determine “two-phase resonant currents be going to flow simultaneously” if the electrical angle determined by calculation, or estimated, based on sensor information provided by a sensor device (such as an encoder or a resolver) for detecting the number of revolutions of a motor falls within a first rotational angle range (e.g., equal to or larger than 55 degrees and equal to or smaller than 65 degrees), or a second rotational angle range (e.g., equal to or larger than 115 degrees and equal to or smaller than 125 degrees), or a third rotational angle range (e.g., equal to or larger than 175 degrees and equal to or smaller than 185 degrees), or a fourth rotational angle range (e.g., equal to or larger than 235 degrees and equal to or smaller than 245 degrees), or a fifth rotational angle range (e.g., equal to or larger than 295 degrees and equal to or smaller than 305 degrees), or a sixth rotational angle range (e.g., equal to or larger than 355 degrees and equal to or smaller than 365 degrees).

For example, each of the plurality of first switching elements 1 and the plurality of second switching elements 2 does not have to be an IGBT but may also be a MOSFET. In that case, each of the plurality of first diodes 4 may also be replaced with, for example, a parasitic diode of a MOSFET serving as its corresponding first switching element 1. In addition, each of the plurality of second diodes 5 may also be replaced with, for example, a parasitic diode of a MOSFET serving as its corresponding second switching element 2. The MOSFET may be, for example, an Si-based MOSFET or an SiC-based MOSFET. Each of the plurality of first switching elements 1 and the plurality of second switching elements 2 may also be, for example, a bipolar transistor or a GaN-based GIT.

Optionally, in the power converters 100, 100A, 100B, 100C, if each of the plurality of resonant capacitors 9 has a relatively small capacitance, then the parasitic capacitors across the plurality of second switching elements 2 may also serve as the plurality of resonant capacitors 9 instead of providing the plurality of resonant capacitors 9 as separate elements.

Furthermore, the length of the dead time period Td does not have to be set to be as long as one resonant half cycle but may also be set to be different from one resonant half cycle.

The dead time period Td may also be set by a dead time generator circuit included in a gate driver integrated circuit (IC) provided separately from the controller 50. Alternatively, the controller 50 may include a gate driver IC and a dead time generator circuit included in the gate driver IC may set the dead time period Td.

Furthermore, the power converter 100, 100A, 100B, 100C does not have to be configured to output three-phase AC power but may also be configured to output multi-phase AC power in more than three phases.

### Aspects

The foregoing description provides specific implementations of the following aspects of the present disclosure.

A power converter (100; 100A; 100B; 100C) according to a first aspect includes a first DC terminal (31) and a second DC terminal (32), a power converter circuit (11), a plurality of AC terminals (41), a plurality of switches (8), a plurality of resonant capacitors (9), a resonant inductor (L1), a regenerative capacitor (15), and a controller (50). The power converter circuit (11) includes a plurality of first switching elements (1) and a plurality of second switching elements (2). In the power converter circuit (11), a plurality of switching circuits (10), in each of which one of the plurality of first switching elements (1) and a corresponding one of the plurality of second switching elements (2) are connected one to one in series, are connected to each other in parallel. In the power converter circuit (11), the plurality of first switching elements (1) are connected to the first DC terminal (31), and the plurality of second switching elements (2) are connected to the second DC terminal (32). The plurality of AC terminals (41) are provided one to one for the plurality of switching circuits (10). Each of the plurality of AC terminals (41) is connected to a connection node (3) between the first switching element (1) and the second switching element (2) of a corresponding one of the plurality of switching circuits (10). The plurality of switches (8) are provided one to one for the plurality of switching circuits (10). Each of the plurality of switches (8) has a first end (81) thereof connected to the connection node (3) between the first switching element (1) and the second switching element (2) of a corresponding one of the plurality of switching circuits (10). The plurality of switches (8) have their respective second ends (82) connected in common to a common connection node (25). The plurality of resonant capacitors (9) are provided one to one for the plurality of switches (8). Each of the plurality of resonant capacitors (9) is connected between the first end (81) of a corresponding one of the plurality of switches (8) and the second DC terminal (32). The resonant inductor (L1) has a first end and a second end. In the resonant inductor (L1), the first end of the resonant inductor (L1) is connected to the common connection node (25). The regenerative capacitor (15) has a third end (153) and a fourth end (154). In the regenerative capacitor (15), the third end (153) of the regenerative capacitor (15) is connected to either the first DC terminal (31) or the second DC terminal (32). The controller (50) applies a control signal, having a potential alternating between a high level and a low level, to each of the plurality of first switching elements (1), the plurality of second switching elements (2), and the plurality of switches (8). When determining that resonant currents passing respectively through two or more switches (8) belonging to the plurality of switches (8) be going to flow simultaneously through the resonant inductor (L1), the controller (50) performs shift control of shifting a high-level period of a control signal for at least one switch (8) out of the two or more switches (8) to prevent the resonant currents passing respectively through the two or more switches (8) from flowing simultaneously through the resonant inductor (L1).

This aspect allows soft switching to be made with more reliability.

In a power converter (100; 100A; 100B; 100C) according to a second aspect, which may be implemented in conjunction with the first aspect, when performing the shift control, the controller (50) shifts the high-level period of the control signal for the at least one switch (8) to prevent high-level periods of control signals to be applied to the first switching element (1) and the second switching element (2) of one switching circuit (10) connected to the at least one switch (8) which belongs to the plurality of switching circuits (10) from changing their length.

This aspect allows the variation in line voltage to be reduced.

In a power converter (100; 100A; 100B; 100C) according to a third aspect, which may be implemented in conjunction with the first or second aspect, when performing the shift control, the controller (50) shifts, in mutually different directions, respective high-level periods of control signals for two switches (8) belonging to the two or more switches (8).

This aspect may contribute to increasing the operating frequency.

In a power converter (100; 100A; 100B; 100C) according to a fourth aspect, which may be implemented in conjunction with any one of the first to third aspects, when determining that resonant currents passing respectively through two switches (8) belonging to the plurality of switches (8) be going to flow simultaneously through the resonant inductor (L1), the controller (50) compares, if polarity of load currents respectively flowing through two AC terminals (41) connected to the two switch (8) which belong to the plurality of AC terminals (41) is positive, respective duties of control signals for two first switching elements (1) corresponding to the two switches (8) which belong to the plurality of first switching elements (1). Then, the controller (50) shifts a high-level period of a control signal for a switch (8) corresponding to the first switching element (1), to which a control signal with a relatively large duty is applied, in such a direction as to advance the high-level period of the control signal and shifts a high-level period of a control signal for a switch (8) corresponding to the first switching element (1), to which a control signal with a relatively small duty is applied, in such a direction as to postpone the high-level period of the control signal. The controller (50) compares, if polarity of the load currents respectively flowing through the two AC terminals (41) connected to the two switches (8) which belong to the plurality of AC terminals (41) is negative, the respective duties of the control signals for the two first switching elements (1) corresponding to the two switches (8) which belong to the plurality of first switching elements (1). Then, the controller (50) shifts the high-level period of the control signal for the switch (8) corresponding to the first switching element (1), to which the control signal with the relatively large duty is applied, in such a direction as to postpone the high-level period of the control signal and shifts the high-level period of the control signal for the switch (8) corresponding to the first switching element (1), to which the control signal with the relatively small duty is applied, in such a direction as to advance the high-level period of the control signal.

This aspect allows soft switching to be made with more reliability when determining that resonant currents passing respectively through two switches (8) belonging to the plurality of switches (8) be going to flow simultaneously through the resonant inductor (L1).

In a power converter (100; 100A; 100B; 100C) according to a fifth aspect, which may be implemented in conjunction with any one of the first to third aspects, when determining that resonant currents passing respectively through two switches (8) belonging to the plurality of switches be going to flow simultaneously through the resonant inductor (L1), the controller (50) compares, if polarity of load currents respectively flowing through two AC terminals (41) connected to the two switches (8) which belong to the plurality of AC terminals (41) is positive, respective duties of control signals for two first switching elements (1) corresponding to the two switches (8) which belong to the plurality of first switching elements (1). Then, the controller (50) shifts a high-level period of a control signal for a switch (8) corresponding to the first switching element (1), to which a control signal with a relatively large duty is applied, in such a direction as to postpone the high-level period of the control signal and shifts a high-level period of a control signal for a switch (8) corresponding to the first switching element (1), to which a control signal with a relatively small duty is applied, in such a direction as to advance the high-level period of the control signal. The controller (50) compares, if polarity of the load currents respectively flowing through the two AC terminals (41) connected to the two switches (8) which belong to the plurality of AC terminals (41) is negative, the respective duties of the control signals for the two first switching elements (1) corresponding to the two switches (8) which belong to the plurality of first switching elements (1). Then, the controller (50) shifts the high-level period of the control signal for the switch (8) corresponding to the first switching element (1), to which the control signal with the relatively large duty is applied, in such a direction as to advance the high-level period of the control signal and shifts the high-level period of the control signal for the switch (8) corresponding to the first switching element (1), to which the control signal with the relatively small duty is applied, in such a direction as to postpone the high-level period of the control signal.

This aspect allows soft switching to be made with more reliability when determining that resonant currents passing respectively through two switches (8) belonging to the plurality of switches (8) be going to flow simultaneously through the resonant inductor (L1).

In a power converter (100; 100A; 100B; 100C) according to a sixth aspect, which may be implemented in conjunction with any one of the first to fifth aspects, when determining that resonant currents passing respectively through three switches (8) belonging to the plurality of switches be going to flow simultaneously through the resonant inductor (L1), the controller (50) performs the shift control by shifting, in a single direction, high-level periods of control signals to be respectively applied to two switches (8) out of the three switches (8).

This aspect allows soft switching to be made with more reliability when determining that resonant currents passing respectively through three switches (8) be going to flow simultaneously.

In a power converter (100; 100A; 100B; 100C) according to a seventh aspect, which may be implemented in conjunction with any one of the first to sixth aspects, the plurality of first switching elements (1) includes three first switching elements (1). The plurality of second switching elements (2) includes three second switching elements (2). The plurality of switches includes three switches (8). When determining that resonant currents passing respectively through the three switches (8) be going to flow simultaneously through the resonant inductor (L1), the controller (50) performs, when a first condition is satisfied, first shift control in a situation where a charging operation of charging the plurality of resonant capacitors (9) with electricity is going to be performed and performs, when a second condition is satisfied, second shift control in a situation where a discharging operation of discharging electricity from the plurality of resonant capacitors (9) is going to be performed. The first condition is a condition that a time lag between a beginning time of a high-level period of a control signal which is longest among respective high-level periods of control signals (SU1, SV1, SW1) to be applied to the three first switching elements (1), respectively, and a beginning time of a high-level period of a control signal which is shortest among the respective high-level periods of the control signals (SU1, SV1, SW1) to be applied to the three first switching elements (1) be longer than a resonant half cycle (Tres). The resonant half cycle (Tres) is a value that is one half of a resonant cycle which is determined by a reciprocal of a resonant frequency of a resonant circuit including the resonant inductor (L1) and one of the plurality of resonant capacitors (9). The first shift control includes control of shifting a high-level period of a control signal for a switch (8) corresponding to a first switching element (1), to which a control signal, having a second longest high-level period among the control signals (SU1, SV1, SW1) to be applied to the three first switching elements (1), respectively, is applied. The second condition is a condition that a time lag between a beginning time of a high-level period of a control signal which is longest among respective high-level periods of control signals (SU2, SV2, SW2) to be applied to the three second switching elements (2), respectively, and a beginning time of a high-level period of a control signal which is shortest among the respective high-level periods of the control signals (SU2, SV2, SW2) to be applied to the three second switching elements (2), respectively, be longer than the resonant half cycle (Tres). The second shift control includes control of shifting a high-level period of a control signal for a switch (8) corresponding to a second switching element (2), to which a control signal, having a second longest high-level period among the control signals (SU2, SV2, SW2) to be applied to the three second switching elements (2), respectively, is applied.

This aspect allows, in the case of a charging operation, the three first switching elements (1) to be soft-switched by shifting the high-level period of a control signal for one switch (8) belonging to the plurality of switches (8), and also allows, in the case of a discharging operation, the three second switching elements (2) to be soft-switched by shifting the high-level period of a control signal for one switch (8) belonging to the plurality of switches (8).

### INDUSTRIAL APPLICABILITY

A power converter according to the present disclosure allows soft switching to be made with more reliability, thus further improving the reliability of the power converter. As can be seen, the power converter according to the present disclosure is effectively applicable to various fields on an industrial basis.

### REFERENCE SIGNS LIST

1 First Switching Element
2 Second Switching Element
3 Connection Node
8 Switch
9 Resonant Capacitor
10 Switching Circuit
11 Power Converter Circuit
15 Regenerative Capacitor
153 Third End
154 Fourth End
31 First DC Terminal
32 Second DC Terminal
41 AC Terminal
50 Controller
100, 100A, 100B, 100C Power Converter
iU, iV, iW Output Current (Load Current)
L1 Resonant Inductor
RA1 AC
SU1, SU2, SU6, SU7 Control Signal
SV1, SV2, SV6, SV7 Control Signal
SW1, SW2, SW6, SW7 Control Signal
Tres Resonant Half Cycle

1. A power converter comprising:
a first DC terminal and a second DC terminal;
a power converter circuit including a plurality of first switching elements and a plurality of second switching elements, the power converter circuit being implemented as a parallel connection of a plurality of switching circuits in each of which one of the plurality of first switching elements and a corresponding one of the plurality of second switching elements are connected one to one in series, the plurality of first switching elements being connected to the first DC terminal, the plurality of second switching elements being connected to the second DC terminal;
a plurality of AC terminals provided one to one for the plurality of switching circuits, each of the plurality of AC terminals being connected to a connection node between the first switching element and the second switching element of a corresponding one of the plurality of switching circuits;
a plurality of switches provided one to one for the plurality of switching circuits, each of the plurality of switches having a first end thereof connected to the connection node between the first switching element and the second switching element of a corresponding one of the plurality of switching circuits, the plurality of switches having their respective second ends connected in common to a common connection node;
a plurality of resonant capacitors provided one to one for the plurality of switches, each of the plurality of resonant capacitors being connected between the first end of a corresponding one of the plurality of switches and the second DC terminal;
a resonant inductor having a first end and a second end, the first end of the resonant inductor being connected to the common connection node;
a regenerative capacitor having a third end and a fourth end, the third end of the regenerative capacitor being connected to either the first DC terminal or the second DC terminal; and
a controller configured to apply a control signal, having a potential alternating between a high level and a low level, to each of the plurality of first switching elements, the plurality of second switching elements, and the plurality of switches,
the controller being configured to, when determining that resonant currents passing respectively through two or more switches belonging to the plurality of switches be going to flow simultaneously through the resonant inductor, perform shift control of shifting a high-level period of a control signal for at least one switch out of the two or more switches to prevent the resonant currents passing respectively through the two or more switches from flowing simultaneously through the resonant inductor.

2. The power converter of claim 1, wherein
the controller is configured to, when performing the shift control, shift the high-level period of the control signal for the at least one switch to prevent high-level periods of control signals to be applied to the first switching element and the second switching element of one switching circuit connected to the at least one switch which belongs to the plurality of switching circuits from changing their length.

3. The power converter of claim 1, wherein
the controller is configured to, when performing the shift control, shift, in mutually different directions, respective high-level periods of control signals for two switches belonging to the two or more switches.

4. The power converter of claim 1, wherein
the controller is configured to, when determining that resonant currents passing respectively through two switches belonging to the plurality of switches be going to flow simultaneously through the resonant inductor,
compare, when polarity of load currents respectively flowing through two AC terminals connected to the two switches which belong to the plurality of AC terminals is positive, respective duties of control signals for two first switching elements corresponding to the two switches which belong to the plurality of first switching elements to shift a high-level period of a control signal for a switch corresponding to the first switching element, to which a control signal with a relatively large duty is applied, in such a direction as to advance the high-level period of the control signal and to shift a high-level period of a control signal for a switch corresponding to the first switching element, to which a control signal with a relatively small duty is applied, in such a direction as to postpone the high-level period of the control signal, and
compare, when polarity of the load currents respectively flowing through the two AC terminals connected to the two switches which belong to the plurality of AC terminals is negative, the respective duties of the control signals for the two first switching elements corresponding to the two switches which belong to the plurality of first switching elements to shift the high-level period of the control signal for the switch corresponding to the first switching element, to which the control signal with the relatively large duty is applied, in such a direction as to postpone the high-level period of the control signal and to shift the high-level period of the control signal for the switch corresponding to the first switching element, to which the control signal with the relatively small duty is applied, in such a direction as to advance the high-level period of the control signal.

5. The power converter of claim 1, wherein
the controller is configured to, when determining that resonant currents passing respectively through two switches belonging to the plurality of switches be going to flow simultaneously through the resonant inductor,
compare, when polarity of load currents respectively flowing through two AC terminals connected to the two switches which belong to the plurality of AC terminals is positive, respective duties of control signals for two first switching elements corresponding to the two switches which belong to the plurality of first switching elements to shift a high-level period of a control signal for a switch corresponding to the first switching element, to which a control signal with a relatively large duty is applied, in such a direction as to postpone the high-level period of the control signal and to shift a high-level period of a control signal for a switch corresponding to the first switching element, to which a control signal with a relatively small duty is applied, in such a direction as to advance the high-level period of the control signal, and
compare, when polarity of the load currents respectively flowing through the two AC terminals connected to the two switches which belong to the plurality of AC terminals is negative, the respective duties of the control signals for the two first switching elements corresponding to the two switches which belong to the plurality of first switching elements to shift the high-level period of the control signal for the switch corresponding to the first switching element, to which the control signal with the relatively large duty is applied, in such a direction as to advance the high-level period of the control signal and to shift the high-level period of the control signal for the switch corresponding to the first switching element, to which the control signal with the relatively small duty is applied, in such a direction as to postpone the high-level period of the control signal.

6. The power converter of claim 1, wherein
the controller is configured to, when determining that resonant currents passing respectively through three switches belonging to the plurality of switches be going to flow simultaneously through the resonant inductor,
perform the shift control by shifting, in a single direction, high-level periods of control signals to be respectively applied to two switches out of the three switches.

7. The power converter of claim 1, wherein
the plurality of first switching elements includes three first switching elements,
the plurality of second switching elements includes three second switching elements,
the plurality of switches includes three switches,
the controller is configured to, when determining that resonant currents passing respectively through the three switches be going to flow simultaneously through the resonant inductor,
perform, when a first condition is satisfied, first shift control in a situation where a charging operation of charging the plurality of resonant capacitors with electricity is going to be performed,
the first condition is a condition that a time lag between a beginning time of a high-level period of a control signal which is longest among respective high-level periods of control signals to be applied to the three first switching elements and a beginning time of a high-level period of a control signal which is shortest among the respective high-level periods of the control signals to be applied to the three first switching elements be longer than a resonant half cycle,
the resonant half cycle is a value that is one half of a resonant cycle, the resonant cycle being determined by a reciprocal of a resonant frequency of a resonant circuit, the resonant circuit including the resonant inductor and one of the plurality of resonant capacitors,
the first shift control includes control of shifting a high-level period of a control signal for a switch corresponding to a first switching element, to which a control signal, having a second longest high-level period among the control signals to be applied to the three first switching elements, is applied,
the controller is configured to perform, when a second condition is satisfied, second shift control in a situation where a discharging operation of discharging electricity from the plurality of resonant capacitors is going to be performed,
the second condition is a condition that a time lag between a beginning time of a high-level period of a control signal which is longest among respective high-level periods of control signals to be applied to the three second switching elements and a beginning time of a high-level period of a control signal which is shortest among the respective high-level periods of the control signals to be applied to the three second switching elements be longer than the resonant half cycle, and
the second shift control includes control of shifting a high-level period of a control signal for a switch corresponding to a second switching element, to which a control signal, having a second longest high-level period among the control signals to be applied to the three second switching elements, is applied.
